(19) United States
(12) Patent Application Publication
(10) Pub. No.: US 2025/0083229 A1
(43) Pub. Date: Mar. 13, 2025

(54) JOINING METHOD, JOINING DEVICE, AND JOINING SYSTEM

(71) Applicant: Mitsubishi Electric Corporation, Tokyo (JP)

(72) Inventors: Nobuhiro SHINOHARA, Tokyo (JP); Daiji MORITA, Tokyo (JP); Takashi YUZAWA, Tokyo (JP)

(73) Assignee: Mitsubishi Electric Corporation, Tokyo (JP)

(21) Appl. No.: 18/292,941

(22) PCT Filed: Aug. 3, 2021
(86) PCT No.: PCT/JP2021/028728

§ 371 Date: Jan. 29, 2024

(51) Int. Cl. B22F 7/06; B22F 10/66; B33Y 40/20

(52) U.S. Cl. CPC B22F 7/062; B22F 10/66; B33Y 40/20

(57) ABSTRACT

A joining method includes: an additive manufacturing step for performing additive manufacturing of a joining pin in a machining region on a joining surface of a joining base material, by supplying a first shaping material to the machining region, and heating and melting for supplying a heat source to melt the shaping material; a disposing step for disposing a joining base material and a joining material having a through hole (H1) such that the joining pin passes through the through hole and protrudes from the through hole; and a machining step for forming a fixed protrusion that fixes the joining base material and the joining material by machining a protrusion of the joining pin protruding from the through hole. The outer circumferential shape of the fixed protrusion viewed from a pass-through direction is larger than that of an outlet of the through hole.

### FIELD

The present disclosure relates to a joining method, a joining device, and a joining system for joining the materials to be joined together.

### BACKGROUND

In recent years, in various fields where the total weight greatly affects the environmental performance, such as automobiles, railways, buildings, machines, and aircrafts, technology has been developed to reduce the weight by replacing a part of the steel material to be used with lightweight metals such as aluminum, magnesium, and light alloys. In the building field, for example, each company has been promoting weight reduction and cost reduction of buildings by selectively using a plurality of materials for different places of use, such as using high tensile strength steel for structural members and using aluminum materials for non-structural members. In the automobile field, for example, each company has been promoting weight reduction of the vehicle body through development of multi-material vehicle bodies by selectively using a plurality of materials such as steel material, aluminum, magnesium, and carbon fiber reinforced plastics (CFRP) for appropriate parts.

Methods of combining a plurality of materials as described above need to achieve both weight reduction and rigidity. Therefore, it is necessary to join dissimilar materials (different materials) with high strength. Typical joining methods include mechanical fastening, adhesion, deformation pressure joining, melting, and the like; in particular, spot welding allows for firm joining. However, spot welding is supposed to be applied mainly to joining of metal parts of the same kind. This is because joining different kinds of metals yields brittle intermetallic compounds that easily crack at the joint portion, and a good welded joint cannot be obtained. For aircrafts and the like subjected to repeated stress, welding is hardly used so as to prevent the influence of intermetallic compounds; instead, structural adhesives or rivets are mainly used.

In the method for manufacturing a mold model described in Patent Literature 1, a snap-fit structure is formed in the additive manufacturing model, and a pilot hole engageable with the snap-fit structure of the additive manufacturing model is formed in the surface plate. Thus, in the method for manufacturing a mold model described in Patent Literature 1, the additive manufacturing model is accurately installed on the surface plate in a short time by fitting the snap-fit structure into the pilot hole.

### CITATION LIST

### Patent Literature

Patent Literature 1: JP 2019-141853 A

### SUMMARY OF INVENTION

### Problem to be Solved by the Invention

However, in the technique of Patent Literature 1, because the mold model is fit into the surface plate using the elasticity of the material, a considerable gap exists at the interface between the materials to be joined, causing rattling, looseness, and the like in the joined portion. For this reason, the technique of Patent Literature 1 is problematic in that it is not possible to firmly join the materials to be joined such as the mold model and the surface plate.

The present disclosure has been made in view of the above, and an object thereof is to obtain a joining method that allows for firm joining of the materials to be joined.

### Means to Solve the Problem

In order to solve the above-described problems and achieve the object, a joining method according to the present disclosure includes an additive manufacturing step for performing, by a joining device, additive manufacturing of a joining pin that is a pin-shaped member in a machining region on a joining surface of a first material body to be joined made of a first material, by performing material supply for supplying a first shaping material to the machining region, and heating and melting for supplying a heat source for heating to the machining region to melt the first shaping material. The joining method according to the present disclosure includes a disposing step for disposing, by the joining device, the first material body to be joined and a second material body to be joined made of a second material different from the first material and having a through hole that allows the joining pin to pass through, such that the joining pin passes through the through hole and protrudes from the through hole. The joining method according to the present disclosure includes a machining step for forming, by the joining device, a fixed protrusion that fixes the first material body to be joined and the second material body to be joined by machining a protrusion that is a portion of the joining pin protruding from the through hole. A first outer circumferential shape that is an outer circumferential shape of the fixed protrusion viewed from a pass-through direction is larger than a second outer circumferential shape that is an outer circumferential shape of an outlet of the through hole from which the protrusion protrudes.

### Effects of the Invention

The joining method according to the present disclosure can achieve the effect of allowing for firm joining of the materials to be joined.

### BRIEF DESCRIPTION OF DRAWINGS

FIG. 1 is a diagram illustrating a configuration of a joining system according to the first embodiment.

FIG. 2 is a diagram illustrating a cross-sectional configuration of the machining head included in the joining system according to the first embodiment.

FIG. 3 is a diagram illustrating an exemplary configuration of the stage rotation mechanism included in the joining system according to the first embodiment.

FIG. 4 is a diagram for explaining temperature diffusion in the case that the height of the joining pin is low during additive manufacturing by the joining system according to the first embodiment.

FIG. 5 is a diagram for explaining temperature diffusion in the case that the height of the joining pin is high during additive manufacturing by the joining system according to the first embodiment.

FIG. 6 is a diagram illustrating a configuration of the control unit included in the joining system according to the first embodiment.

FIG. 7 is a flowchart illustrating a procedure for the joining process by the joining device according to the first embodiment.

FIG. 8 is a diagram for explaining the joining process by the joining device according to the first embodiment.

FIG. 9 is a diagram for explaining the joining process without an anti-electrolytic-corrosion sheet sandwiched by the joining device according to the first embodiment.

FIG. 10 is a diagram for explaining a first different shape example of the protrusion of the joining pin formed by the joining device according to the first embodiment.

FIG. 11 is a diagram for explaining a second different shape example of the protrusion of the joining pin formed by the joining device according to the first embodiment.

FIG. 12 is a diagram for explaining a different shape example of the joining pin that is additively manufactured by the joining device according to the first embodiment.

FIG. 13 is a diagram for explaining a third different shape example of the protrusion of the joining pin that is additively manufactured by the joining device according to the first embodiment.

FIG. 14 is a diagram for explaining a fourth different shape example of the protrusion of the joining pin that is additively manufactured by the joining device according to the first embodiment.

FIG. 15 is a diagram for explaining the additive manufacturing process of a covering portion by the joining device according to the first embodiment.

FIG. 16 is a diagram for explaining the joining process by the joining device according to the second embodiment.

FIG. 17 is a diagram for explaining the joining process by the joining device according to the third embodiment.

FIG. 18 is a diagram for explaining the joining process by the joining device according to the fourth embodiment.

FIG. 19 is a diagram for explaining the joining process by the joining device without using a protrusion according to the fourth embodiment.

FIG. 20 is a diagram illustrating a configuration of a joining system according to the fifth embodiment.

FIG. 21 is a diagram illustrating a configuration of the control unit included in the joining system according to the fifth embodiment.

FIG. 22 is a flowchart illustrating a procedure for operation processing of the control unit according to the fifth embodiment.

FIG. 23 is a diagram illustrating an exemplary configuration of processing circuitry in the case that the processing circuitry provided in the control unit according to the first to fifth embodiments is implemented by a processor and a memory.

FIG. 24 is a diagram illustrating an example of processing circuitry in the case that the processing circuitry provided in the control unit according to the first to fifth embodiments is implemented by dedicated hardware.

### DESCRIPTION OF EMBODIMENTS

Hereinafter, a joining method, a joining device, and a joining system according to embodiments of the present disclosure will be described in detail with reference to the drawings.

### First Embodiment

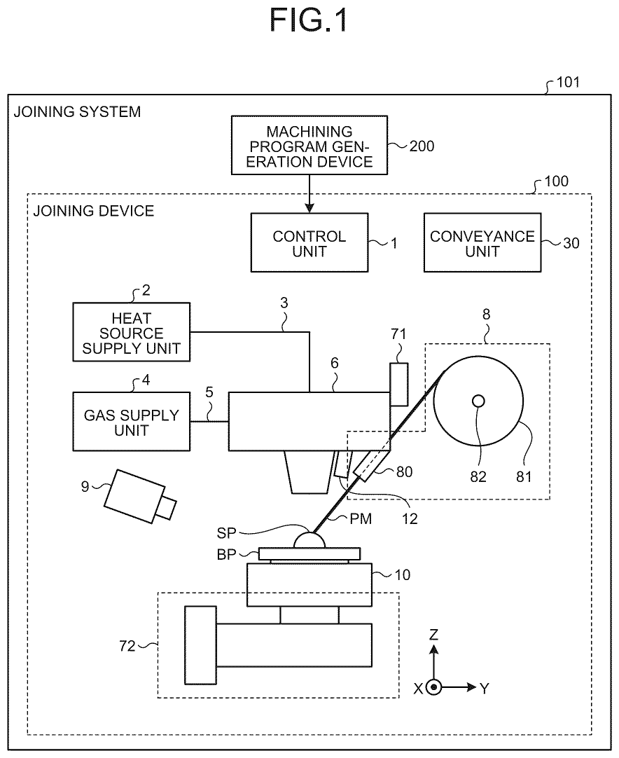

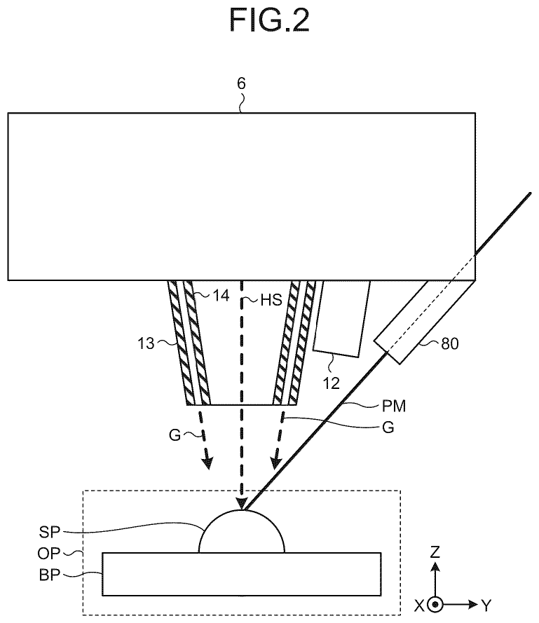

FIG. 1 is a diagram illustrating a configuration of a joining system according to the first embodiment. FIG. 2 is a diagram illustrating a cross-sectional configuration of the machining head included in the joining system according to the first embodiment. Hereinafter, two axes orthogonal to each other on a plane parallel to the horizontal plane are referred to as the X axis and the Y axis. The axis orthogonal to the X axis and the Y axis is referred to as the Z axis. That is, the Z-axis direction is parallel to the vertical direction. The first embodiment describes a joining process in which the materials to be joined are a plate-like joining base material BP and a plate-like joining material PP, and the upper surfaces of the joining base material BP and the joining material PP are parallel to an XY plane.

The joining system 101 includes a joining device 100 and a machining program generation device 200. The machining program generation device 200 generates a basic machining program BPR, which is a machining program for controlling the joining device 100, and sends the basic machining program BPR to the joining device 100.

The joining device 100, which is an additive manufacturing device, is a joining device having an additive manufacturing function of the directed energy deposition (DED) type. Based on the basic machining program BPR, the joining device 100 heats and melts a wire-like shaping material PM with a heat source HS for heating, and adds the melted shaping material PM to the joining base material BP or the like. The joining base material BP is a material serving as a base for joining. For example, the joining device 100 additively manufactures a joining pin SP by adding the shaping material PM to the joining base material BP while rotating the joining base material BP in various directions. The joining pin SP is a pin-shaped additively manufactured object that is used for joining the joining base material BP and the joining material PP. The shaping material PM is a first shaping material.

The joining device 100 includes a control unit 1 that controls the joining device 100, a heat source supply unit 2 that supplies the heat source HS, and a heat source path 3 that guides the heat source HS from the heat source supply unit 2 to the machining head 6. In addition, the joining device 100 includes a shaping material supply unit 8 that supplies the shaping material PM toward the machining region, which is the joining position, and a wire nozzle 80 that directs the supply direction of the shaping material PM toward the joining position. In addition, the joining device 100 includes a machining head drive unit 71 that changes the relative position between the joining target (material to be joined) and the machining head 6, a gas supply unit 4 that supplies a shield gas G, and a gas supply path 5 that connects a gas nozzle 13 and the gas supply unit 4. The shaping material supply unit 8 includes a wire spool 81 that stores the shaping material PM, and a spool drive device 82 that drives the wire spool 81.

The spool drive device 82 of the shaping material supply unit 8 rotates the wire spool 81 to feed out the wire made of the shaping material PM, and supplies the wire as a material toward the wire nozzle 80. Note that the shaping material PM supplied by the shaping material supply unit 8 may be the same as or different from the joining material PP. That is, the shaping material PM supplied by the shaping material supply unit 8 may be any material as long as it can be additively manufactured on the joining material PP.

In addition, the wire nozzle 80 may eject a powder material with high pressure air or the like, instead of using wire as the shaping material PM. Examples of the form of the shaping material PM include linear, powder, liquid, and paste. Examples of the substance of the shaping material PM include metal and resin.

The machining head 6 includes the gas nozzle 13 and a heat source supply nozzle 14. The outer shapes of the gas nozzle 13 and the heat source supply nozzle 14 are the side surface shape of a truncated cone. Suppose that the outer shape of the gas nozzle 13 is a first truncated cone, and the outer shape of the heat source supply nozzle 14 is a second truncated cone. In this case, the first truncated cone is disposed surrounding the outer circumference of the second truncated cone. In this case, by making the diameters of the upper base and the lower base of the second truncated cone smaller than the diameters of the upper base and the lower base of the first truncated cone, respectively, the supply paths of the shield gas G and the heat source HS can be made different until immediately before the emission while the gas nozzle 13 and the heat source supply nozzle 14 are coaxially configured.

In this manner, in the machining head 6, the gas nozzle 13 and the heat source supply nozzle 14 have a rotationally symmetrical shape with respect to one rotation axis. As a result, the machining head 6 can supply the heat source HS and the shield gas G to the machining position on one axis. In addition, the machining head 6 can eject the shield gas G such that the shield gas G surrounds the machining position to which the heat source HS is supplied.

In addition, the joining device 100 includes a temperature measurement unit 9 that measures temperature, a stage 10 to which the joining base material BP is fixed, a stage rotation mechanism 72 that rotates the stage 10, and a dust collector 12 that sucks dust, smoke, and the like. In addition, the joining device 100 includes a conveyance unit 30 that conveys the joining base material BP and the like.

The conveyance unit 30 conveys the joining base material BP, the joining material PP, and the like. The joining base material BP is a material to be joined made of a first material, and the joining material PP is a material to be joined made of a second material different from the first material. The joining base material BP is a first material body to be joined, and the joining material PP is a second material body to be joined. The joining base material BP and the shaping material PM may be the same material or different materials. The joining device 100 joins the joining base material BP and the joining material PP using the shaping material PM.

In addition, the conveyance unit 30 places the joining material PP on the upper surface of the joining base material BP having a pin-shaped member formed as the joining pin SP. The joining material PP has a through hole H1 to be described later, and the conveyance unit 30 causes the joining pin SP to pass through the through hole H1 to align the upper surface of the joining base material BP and the bottom surface of the joining material PP.

The heat source supply unit 2 and the machining head 6 are connected by the heat source path 3. The heat source supply unit 2 supplies the heat source HS to the machining head 6 based on the supply command of the heat source HS (hereinafter referred to as the heat source supply command LC) determined by the control unit 1. As illustrated in FIG. 2, the heat source supply nozzle 14 of the machining head 6 outputs the heat source HS, which is a heat source for heating and melting the shaping material PM, toward the joining base material BP. Examples of the heat source HS can include a laser beam, an electron beam, arc discharge, and Joule heating.

The joining device 100 supplies the heat source HS while supplying the shield gas G to the shaping material PM. The joining device 100 heats and melts the shaping material PM by means of the heat source HS, and adds the melted shaping material PM to the joining base material BP or the like as the joining pin SP to produce an object OP. The joining device 100 heats the shaping material PM to shape the joining pin SP, and produces a joint at which the joining base material BP and the joining material PP are joined using the joining pin SP. The joining pin SP is thus used for joining the joining base material BP and the joining material PP. The first embodiment describes a case where the joining base material BP and the joining material PP are plate-like members, but the joining base material BP and the joining material PP may have any shape.

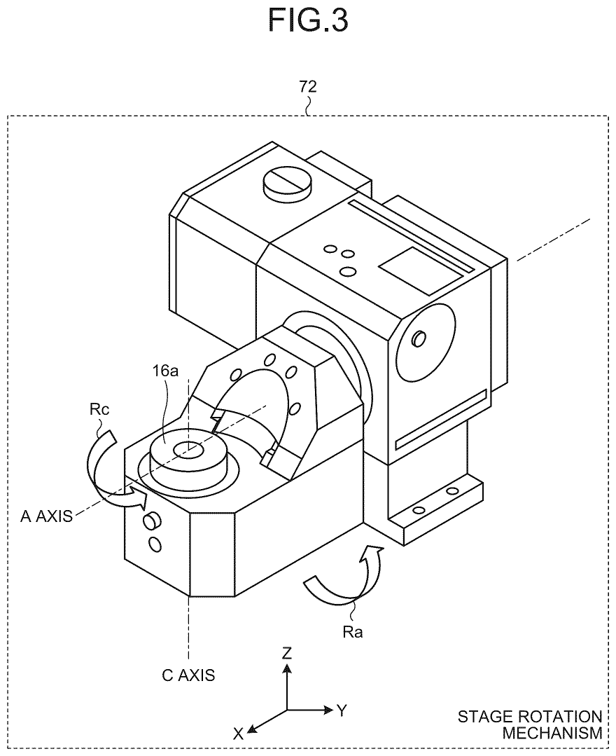

FIG. 3 is a diagram illustrating an exemplary configuration of the stage rotation mechanism included in the joining system according to the first embodiment. FIG. 3 is a perspective view of the stage rotation mechanism 72. The stage rotation mechanism 72 includes a rotation member 16a that rotates about the A axis and the C axis in FIG. 3 serving as rotation axes. The A axis is an axis perpendicular to the C axis. The stage 10 is attached to the rotation member 16a of the stage rotation mechanism 72. In FIG. 3, the stage 10 is not illustrated.

The stage rotation mechanism 72 rotates the rotation member 16a, the stage 10, and the joining base material BP about the A axis or the C axis based on the drive command (hereinafter referred to as the drive command DC) determined by the control unit 1. When the stage 10 rotates, the relative angle, position, and the like between the joining base material BP and the machining head 6 change.

For example, the stage rotation mechanism 72 is configured to independently execute rotation of the rotation member 16a in two rotation directions, that is, rotation in a rotation direction Ra about the A axis as a rotation axis and rotation in a rotation direction Rc about the C axis as a rotation axis. In this manner, the stage 10 is movable in two axial directions with the stage rotation mechanism 72 having the two-axis rotation mechanism of the A axis and the C axis. The stage rotation mechanism 72 can set the A axis and the C axis in any direction. The stage rotation mechanism 72 may have the A axis parallel to the X axis and the C axis parallel to the Z axis.

In addition, for example, the stage rotation mechanism 72 may include a servomotor that implements two rotation directions, namely the rotation direction Ra and the rotation direction Rc. By using the stage rotation mechanism 72, the joining device 100 may additively manufacture the joining pin SP on the joining base material BP having a complicated shape which requires a five-axis configuration for access to the machining position, for example.

As described above, regarding the axial configuration of the joining device 100, for example, the machining head 6 has a three-axis configuration, and the stage 10 on which the joining base material BP is placed has a two-axis configuration of the A axis and the C axis, but the axial configuration of the joining device 100 is not limited thereto. The axial configuration of the joining device 100 may be, for example, a five-axis configuration in which the machining head 6 has a four-axis configuration including a three-axis configuration and a mechanism that makes C-axis rotation about the Z axis, and the stage 10 on which the joining base material BP is placed makes only A-axis rotation.

In addition, the axial configuration of the joining device 100 may be an axial configuration in which the stage 10 on which the joining base material BP is placed has a three-axis configuration, and the machining head 6 is rotated about two axes, the A axis and the C axis. In addition, the joining system 101 may have a multi-axis configuration including five or more axes as a whole. In addition, in cases where the joining device 100 joins only simple shapes, the axial configuration of the joining device 100 may be a limited axial configuration having a narrower movable range, such as three axes or four axes.

The machining head 6 may include an angle adjustment mechanism. For example, the machining head 6 may be fixed to a swivel stage that rotates about the rotation axis whose direction is parallel to the X axis. When the swivel stage is used, the machining head 6 can adjust the inclination angles of the A axis and the B axis in the five-axis drive, and thus the stage 10 does not need to incline the joining base material BP. In some cases where the joining base material BP is a large and heavy object, inclining the joining base material BP increases the inertia of the joining device 100, making it difficult to accurately position and move the joining base material BP at a high speed. Even in such cases, if the machining head 6 is equipped with the rotation mechanism, the joining device 100 does not need to change the angle of the joining base material BP, and can execute the additive manufacturing of the joining pin SP with high accuracy and high speed.

In addition, a laser height measuring instrument for measuring the shaping height (hereinafter referred to as height) of the joining pin SP may be attached to the joining device 100. In this case, the laser height measuring instrument sends height information indicating the height of the joining pin SP to the control unit 1. Then, the control unit 1 controls shaping parameters such as the amount of heat and the wire supply speed for shaping based on the height information of the joining pin SP. As a result, the control unit 1 can perform process control of additive manufacturing to obtain a desired height, and the joining pin SP can be automatically shaped with a desired height.

The joining device 100 may measure the height of the joining pin SP by observing the shaping process. In this case, an overhead camera is attached at a position where the shaping process can be observed from directly above, that is, coaxially with the heat source supply nozzle 14. For example, the control unit 1 measures the height of the joining pin SP by triangulation based on overhead image information, i.e. information of an image of the joining pin SP captured by the overhead camera.

The machining program generation device 200 may be a computer-aided manufacturing (CAM) device that generates the basic machining program BPR for controlling the joining device 100. The machining program generation device 200 generates the basic machining program BPR based on external data input from the outside, such as information on the position, diameter, height, substance (material), and deposit condition of the joining pin SP. The external data input to the machining program generation device 200 may be in a CAD data format or the like as long as the machining program generation device 200 can generate the basic machining program BPR.

In the exemplary configuration of the joining device 100 illustrated in FIG. 1, the joining base material BP is fixed to the upper surface of the stage 10. The joining device 100 adds the joining pin SP by depositing a line bead or a point bead in the vertical direction with respect to the joining base material BP by additive manufacturing using the joining base material BP as a base material. Here, a “line bead” means an object formed of the shaping material PM melted by the heat source HS supplied, added to the joining base material BP or the like, and solidified into a rod shape (or bar shape), and a “point bead” means an object formed of the shaping material PM solidified into a hemispherical shape. The joining pin SP is formed of a plurality of line beads or point beads added. In the joining device 100, the joining pin SP may be produced by additive manufacturing using only one of point shaping and line shaping, or may be produced by additive manufacturing using both point shaping and line shaping. Here, additive manufacturing for forming a line bead is referred to as “line shaping”, and additive manufacturing for forming a point bead is referred to as “point shaping”.

Here, a procedure for deposition processing in the case of point shaping will be described. In the joining device 100, the machining head drive unit 71 moves the machining head 6 to a joining pin producing position at which the joining pin SP is produced on the joining base material BP. In addition, the joining device 100 feeds the shaping material PM from the wire nozzle 80 to the joining pin producing position. In addition, the joining device 100 outputs the heat source HS to the joining pin producing position. Consequently, the joining device 100 melts the shaping material PM fed from the wire nozzle 80 of the machining head 6 to the joining pin producing position. The joining device 100 solidifies the melted shaping material PM into a hemispherical projection by utilizing the surface tension of the molten metal on the joining base material BP, thereby forming a pin layer having a height of one pitch of deposition. This pin layer is the first deposit constituting the joining pin SP. The height of one pitch of deposition is the height of one line bead or one point bead which is additively manufactured at one time.

Next, the machining head drive unit 71 moves the machining head 6 to the shaping position higher by one pitch of deposition. The joining device 100 melts the shaping material PM immediately above the formed projection, that is, just above the formed pin layer, by performing the same process as in the first layer. The joining device 100 solidifies the melted shaping material PM at the upper portion of the first pin layer. The joining device 100 repeats this deposition a plurality of times to produce the joining pin SP consisting of hemispherical pin layers in a plurality of stages.

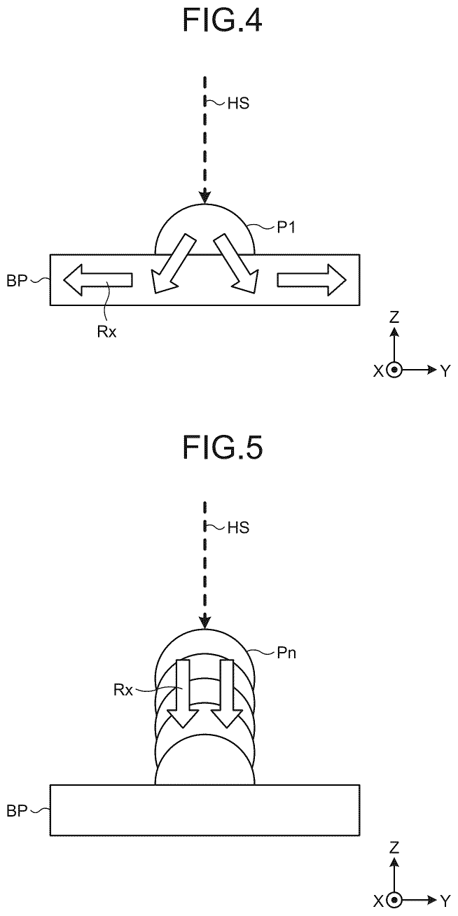

The joining device 100 repeats the deposition of pin layers until the joining pin SP comes to have a desired height. Here, the relationship between the height of the joining pin SP and temperature diffusion will be described. FIG. 4 is a diagram for explaining temperature diffusion in the case that the height of the joining pin is low during additive manufacturing by the joining system according to the first embodiment. FIG. 5 is a diagram for explaining temperature diffusion in the case that the height of the joining pin is high during additive manufacturing by the joining system according to the first embodiment.

FIG. 4 illustrates the pin layer P1 formed at the lower position (first layer in this case) of the joining pin SP, and FIG. 5 illustrates the pin layer Pn formed at the upper position of the joining pin SP. Paths Rx illustrated in FIGS. 4 and 5 are paths through which heat is released, that is, paths of temperature diffusion.

As illustrated in FIGS. 4 and 5, at the time of shaping the joining pin SP, the paths Rx through which heat is released differ between the lower position and the upper position of the joining pin SP. As the joining pin SP extends higher, the paths Rx through which heat escapes become limited, and thus the amount of heat required for melting the shaping material PM decreases. Therefore, in order to deposit beads with stable shapes, it may be necessary to reduce the amount of heat applied from the heat source HS at the upper position depending on the substance of the joining base material BP or the substance of the shaping material PM. The joining device 100 may adjust the amount of heat of the heat source HS radiated from the heat source supply unit 2 so as to obtain a melting temperature within a desired range by measuring the temperature of the shaped portion using the temperature measurement unit 9.

In this case, the control unit 1 controls the amount of heat of the heat source HS radiated by outputting the heat source supply command LC to the heat source supply unit 2. The heat source supply command LC is a command designating the amount of heat of the heat source HS to be supplied by the heat source supply unit 2. For example, a thermo camera, a thermocouple, or the like is used to measure the temperature at the shaping position (machining region) with the temperature measurement unit 9.

In addition, the joining device 100 may correct the basic machining program BPR based on the temperature designated for the shaping position and the temperature at the shaping position measured by the temperature measurement unit 9. In this case, the joining device 100 controls the heat source supply unit 2, the gas supply unit 4, the shaping material supply unit 8, the machining head drive unit 71, the stage rotation mechanism 72, and the like based on the post-correction machining program (post-correction machining program PPR to be described later) obtained by correcting the basic machining program BPR.

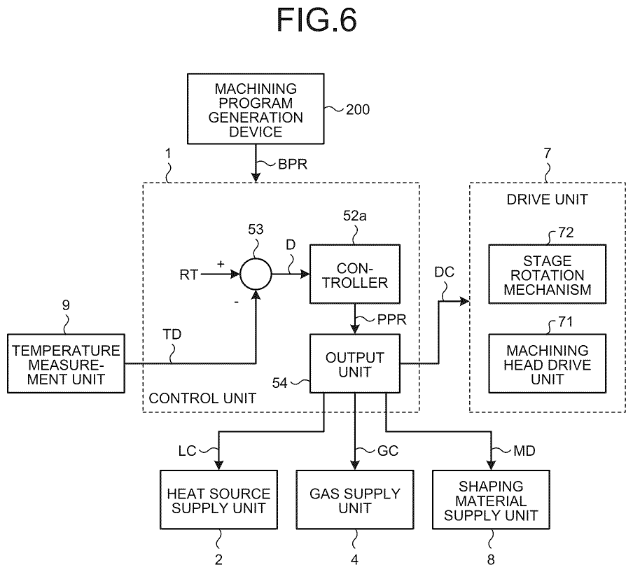

FIG. 6 is a diagram illustrating a configuration of the control unit included in the joining system according to the first embodiment. The control unit 1 is, for example, a numerical control device. The control unit 1 includes a controller 52a, a differentiator 53, and an output unit 54. The joining device 100 also includes a drive unit 7 including the machining head drive unit 71 and the stage rotation mechanism 72.

The control unit 1 acquires the basic machining program BPR from the machining program generation device 200. Here, the basic machining program BPR includes a basic command BCV (not illustrated) for executing additive manufacturing of the joining pin SP, and a joining condition PC (not illustrated) for executing additive manufacturing. The joining condition PC is conditions, parameters, and the like for the machining that the joining device 100 executes.

The basic command BCV is a command before execution of correction by the control unit 1. The basic command BCV is, for example, the heat source supply command LC before correction, a gas supply command GC before correction, a material supply command MD before correction, the drive command DC before correction, or the like.

The heat source supply command LC is a command to the heat source supply unit 2 in which the amount of heat of the heat source HS is designated, and the gas supply command GC is a command to the gas supply unit 4 in which the flow rate of the shield gas G is designated. The material supply command MD is a command to the shaping material supply unit 8 in which the supply speed of the shaping material PM and the like are designated, and the drive command DC is a command to the drive unit 7, that is, a command to the machining head drive unit 71 and the stage rotation mechanism 72.

The drive command DC includes a command to the stage rotation mechanism 72 and a command to the machining head drive unit 71. In the drive command DC, the machining path of the stage 10 and the machining head 6 are designated. The machining path is a movement path that changes the relative position between the machining head 6 and the workpiece consisting of the joining base material BP and the joining pin SP. The drive command DC may include a command designating the rotation amount of the stage 10, a command designating the movement amount of the machining head 6, and the like. The machining path may be a path for shaping the joining pin SP. The machining path may be a path for moving the irradiation position of the heat source HS.

The differentiator 53 receives a command temperature RT of the basic machining program BPR from the machining program generation device 200. The command temperature RT of the basic machining program BPR may be extracted by the machining program generation device 200 from the basic machining program BPR, or may be extracted by the control unit 1 from the basic machining program BPR.

The differentiator 53 receives temperature data TD from the temperature measurement unit 9. The temperature data TD is data indicating the temperature at the shaping position measured by the temperature measurement unit 9. The differentiator 53 calculates a difference D by subtracting the temperature data TD from the command temperature RT and sends the difference D to the controller 52a.

The controller 52a receives the basic machining program BPR from the machining program generation device 200. The controller 52a generates the post-correction machining program PPR by correcting the basic machining program BPR based on the difference D. The controller 52a sends the post-correction machining program PPR to the output unit 54.

The output unit 54 creates the heat source supply command LC, the gas supply command GC, the material supply command MD, and the drive command DC in a complex manner based on the post-correction machining program PPR. The output unit 54 outputs the heat source supply command LC to the heat source supply unit 2, and outputs the gas supply command GC to the gas supply unit 4. The output unit 54 also outputs the material supply command MD to the shaping material supply unit 8, and outputs the drive command DC to the machining head drive unit 71.

The heat source supply command LC, the gas supply command GC, the material supply command MD, and the drive command DC are commands included in a post-correction command CCV (not illustrated) which is a command after correction. In this manner, the control unit 1 determines the heat source supply command LC, the material supply command MD, the gas supply command GC, and the drive command DC as the post-correction command CCV based on the basic machining program BPR and the temperature data TD.

Note that the joining device 100 may use the height of the joining pin SP, instead of the temperature, for shaping. In this case, the joining device 100 measures the height of the joining pin SP by triangulation or the like using a height measuring instrument such as a laser height measuring instrument, an overhead camera, or the like. Then, the control unit 1 controls the objects to be controlled by the control unit 1 based on the difference between the measured height information, which is information on the measured height, and the command height included in the command in which the height of the joining pin SP is designated. The objects to be controlled by the control unit 1 are the heat source supply unit 2, the gas supply unit 4, the shaping material supply unit 8, and the machining head drive unit 71. In addition, the control unit 1 may control the objects to be controlled using the temperature at the time of shaping and information on the height of the joining pin SP in a complex manner.

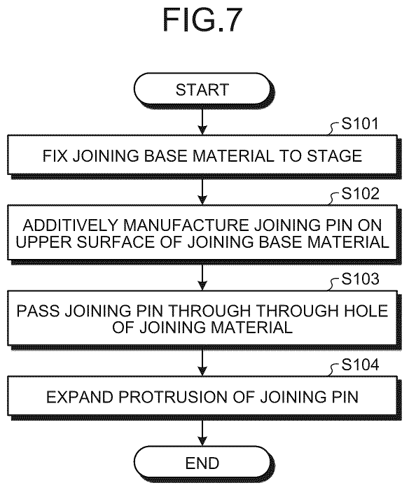

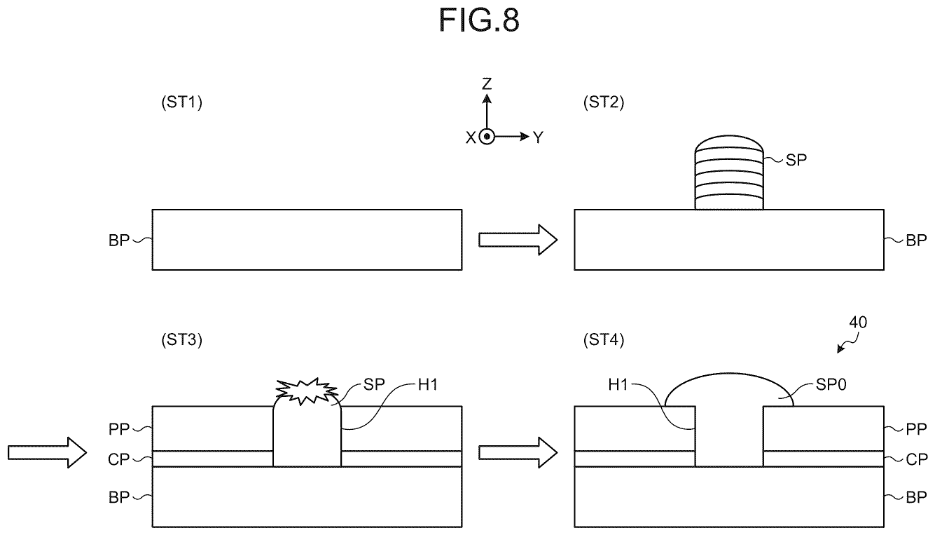

Next, a procedure for the joining process by the joining device 100 will be described. FIG. 7 is a flowchart illustrating a procedure for the joining process by the joining device according to the first embodiment. FIG. 8 is a diagram for explaining the joining process by the joining device according to the first embodiment. FIG. 8 illustrates a cross-sectional shape of the joining base material BP and the like.

The joining device 100 conveys the joining base material BP to the stage 10 by means of the conveyance unit 30, and fixes the joining base material BP to the stage 10 (step S101). In FIG. 8, a state of the joining base material BP fixed to the stage 10 (not illustrated in FIG. 8) is illustrated as (ST1).

The joining device 100 additively manufactures the joining pin SP on the upper surface of the joining base material BP (step S102). In FIG. 8, a state in which the joining pin SP is additively manufactured on the upper surface of the joining base material BP is illustrated as (ST2). The joining device 100 shapes the joining pin SP such that the height of the joining pin SP is higher than the height of the joining material PP.

The through hole H1 for fitting the joining pin SP formed on the upper surface of the joining base material BP is formed with a drill or the like in the joining material PP that is joined to the joining base material BP. Other machining methods such as laser, electric discharge, and press machining may be used for forming the through hole H1. In addition, the joining material PP having the through hole H1 made in advance may be used. In addition, the joining device 100 may use the laser beam radiated from the machining head 6 for drilling the joining material PP. The through hole H1 is a pillar-like space. The through hole H1 may have a columnar shape, a polygonal columnar shape, or any other pillar-like shape.

The conveyance unit 30 conveys the joining material PP to the stage 10. The conveyance unit 30 disposes the joining material PP on the upper surface of the joining base material BP such that the joining pin SP shaped on the joining base material BP passes through the through hole H1 of the joining material PP. That is, the conveyance unit 30 passes the joining pin SP through the through hole H1 of the joining material PP (step S103). As a result, the head portion of the joining pin SP passes through the through hole H1 and protrudes from the through hole H1 as a protrusion. The protrusion of the joining pin SP protruding from the through hole H1 is one end (upper end) of the joining pin SP, and the other end (lower end) of the joining pin SP is joined to the upper surface of the joining base material BP.

When disposing the joining material PP on the upper surface of the joining base material BP, the joining device 100 may perform a process for preventing electric corrosion due to contact between dissimilar metals after joining. For example, the joining device 100 may sandwich an anti-electrolytic-corrosion sheet CP consisting of a petrolatum-based anticorrosion tape or the like between the joining base material BP and the joining material PP. The material of the anti-electrolytic-corrosion sheet CP is a silicone, a modified silicone, a plate material or a liquid agent of a resin, a tape, or the like. Similarly to the joining material PP, the anti-electrolytic-corrosion sheet CP also has the through hole H1 through which the joining pin SP passes.

The anti-electrolytic-corrosion sheet CP is formed of a material having a potential difference of less than 100 mV with respect to both the material of the joining base material BP and the material of the joining material PP. Note that an insulating material may be disposed between the joining base material BP and the joining material PP instead of the anti-electrolytic-corrosion sheet CP.

In addition, the joining device 100 may dispose the joining base material BP and the joining material PP with a certain gap, and perform brazing or the like to fill the gap with another material having a small difference in metal ionization tendency from both the joining base material BP and the joining material PP. For brazing, existing brazing equipment may be used, or brazing by the heat source HS may be executed by attaching a spool containing a brazing wire or a tank of powder material to the shaping material supply unit 8 of the joining device 100.

Generally, the best way to prevent electrolytic corrosion is to cover each of the dissimilar materials, protect the contact surface with oils and fats, or insulate the dissimilar materials from each other. Otherwise, combinations of dissimilar materials at least having a mutual potential difference in corrosion potential of less than 100 mV are considered acceptable.

Whether dissimilar materials can be combined and the mutual potential difference therebetween can be estimated from the metal ionization tendency of each material if the metal ionization tendency is known. In addition, if the potential with respect to the standard hydrogen electrode or the reference electrode is individually measured in advance, it is possible to precisely determine whether dissimilar materials can be combined.

The joining device 100 starts joining the joining base material BP and the joining material PP after disposing the joining material PP on the joining base material BP and processing the gap between the joining base material BP and the joining material PP as necessary. Specifically, the joining device 100 performs swaging in which the protrusion of the joining pin SP protruding on the joining material PP is melted with the heat source HS and deformed into a flat shape. The flat shape of the protrusion of the joining pin SP is such that the entire bottom surface of the swaged protrusion is in contact with the upper surface of the joining material PP. In FIG. 8, a state in which the protrusion of the joining pin SP is melted with the heat source HS is illustrated as (ST3). Swaging alters the protrusion of the joining pin SP into a circular shape with which the entire through hole H1 can be covered when viewed from above.

The joining device 100 expands the protrusion of the joining pin SP by performing swaging that deforms the protrusion of the joining pin SP (step S104). The joining pin SP with the expanded protrusion is a joining pin SP0. As a result, the joining device 100 produces a joint 40 at which the joining base material BP and the joining material PP are joined. In FIG. 8, a state of the joint 40 at which the joining base material BP and the joining material PP are joined by the joining pin SP0 with the expanded protrusion is illustrated as (ST4). Here, the protrusion of the joining pin SP0 is a fixed protrusion formed by machining of the joining pin SP.

The shape of the protrusion of the joining pin SP0 is such that the outer circumferential shape of the protrusion of the joining pin SP0 viewed from the pass-through direction is larger than the outer circumferential shape of the outlet of the through hole H1. The outlet of the through hole H1 is the portion through which the protrusion of the joining pin SP passes and protrudes. The outer circumferential shape of the protrusion of the joining pin SP0 viewed from the pass-through direction is a first outer circumferential shape, and the outer circumferential shape of the outlet of the through hole H1 from which the protrusion protrudes is a second outer circumferential shape.

Note that the joining device 100 may swage the protrusion of the joining pin SP by performing deformation processing with physical impact using a hammer, a swaging tool, or the like, or by using other plastic processing means such as press. That is, the joining device 100 may deform the protrusion by applying pressure to the protrusion to press the protrusion against the joining material PP. The joining device 100 can improve the degree of close contact and the joining strength between the joining pin SP0 and the joining material PP by applying pressure to the protrusion when swaging the protrusion.

When the thickness of the joining material PP is thin or the diameter of the through hole H1 is large, the joining device 100 may first dispose the joining material PP and the anti-electrolytic-corrosion sheet CP on the joining base material BP, and then perform additive manufacturing of the joining pin SP and swaging in which the protrusion of the joining pin SP is deformed. This method can be used mainly when the molten bead can be poured into the through hole H1 or when the machining head 6 can enter the through hole H1 to additively manufacture the joining pin SP. In these cases, there is no need to perform a step of searching for the joining condition PC for additively manufacturing the joining pin SP having a diameter corresponding to the diameter of the through hole H1 of the joining material PP and calibrating the joining condition PC. This leads to labor saving and time reduction in step and condition setting.

The joining device 100 can freely change the size, shape, height, and the like of the joining pin SP by altering the shaping conditions by the control unit 1. That is, the joining device 100 can produce the joining pin SP having a large cross-sectional size by supplying the heat source HS and the shaping material PM for a long time when shaping the height corresponding to one pitch of deposition. In addition, the joining device 100 can also adjust the height and cross-sectional area of the joining pin SP0 by radiating only the heat source HS after the point shaping of one pitch of deposition to remelt the surface of the joining pin SP so that the protrusion of the joining pin SP0 has a flat shape with a larger cross section.

When the heat dissipation of the joining base material BP is large, or when the shaping material PM for use in shaping is a material that does not easily melt, the joining device 100 may start the point shaping after preheating the surface of the joining base material BP or the joining pin SP produced one pitch before with the heat source HS before the point shaping. The above shaping method can be similarly applied to line shaping.

In the first embodiment, the case where the anti-electrolytic-corrosion sheet CP is sandwiched between the joining base material BP and the joining material PP has been described, but the anti-electrolytic-corrosion sheet CP need not necessarily be used. In this case, a combination of materials having less influence of electrolytic corrosion between the joining base material BP, the joining pin SP, and the joining material PP is selected.

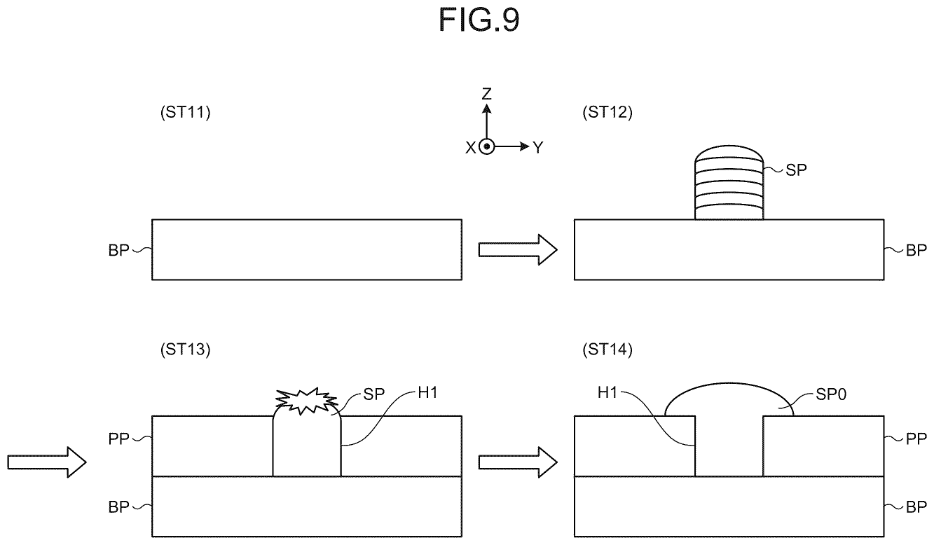

FIG. 9 is a diagram for explaining the joining process without an anti-electrolytic-corrosion sheet sandwiched by the joining device according to the first embodiment. FIG. 9 illustrates a cross-sectional shape of the joining base material BP and the like.

The state (ST11) in FIG. 9 is the same as the state (31) in FIG. 8. The state (ST12) in FIG. 9 is the same as the state (S2) in FIG. 8.

In FIG. 9, a state in which the protrusion of the joining pin SP is melted with the heat source HS is illustrated as (ST13). In (ST13), when the joining device 100 melts the protrusion of the joining pin SP with the heat source HS, the anti-electrolytic-corrosion sheet CP is not sandwiched between the joining base material BP and the joining material PP. In FIG. 9, a state in which the protrusion of the joining pin SP is expanded and the joining base material BP and the joining material PP are joined is illustrated as (ST14).

The shape of the protrusion of the joining pin SP with which the joining device 100 joins the joining base material BP and the joining material PP is not limited to the flat shape of the bottom surface. That is, the protrusion of the joining pin SP may have a shape such that a part of the bottom surface of the protrusion is not in contact with the upper surface of the joining material PP.

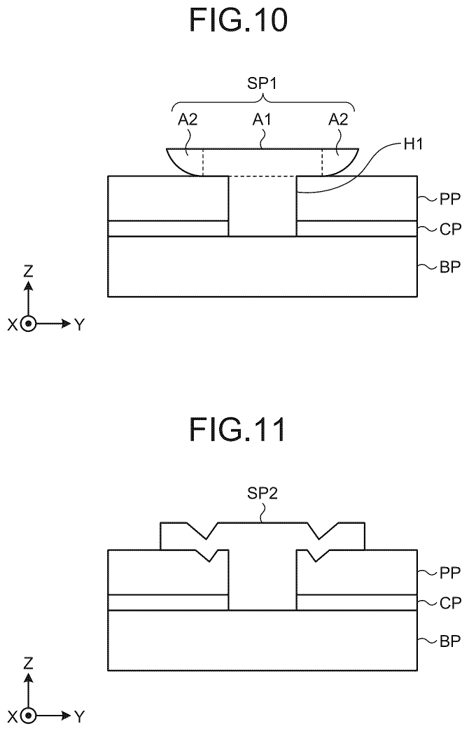

FIG. 10 is a diagram for explaining a first different shape example of the protrusion of the joining pin formed by the joining device according to the first embodiment. FIG. 10 illustrates a cross-sectional shape of the joining pin SP1 in which the bottom surface of the protrusion does not have a flat shape. Here, the protrusion of the joining pin SP1 is a fixed protrusion formed by machining of the joining pin SP.

For example, only a central region A1 of the protrusion of the joining pin SP1 viewed from above may be in contact with the upper surface of the joining material PP, and an outer circumferential region A2 may be formed at a position apart from the upper surface of the joining material PP without being in contact with the upper surface of the joining material PP. The protrusion of the joining pin SP1 only needs to be larger than the opening region of the through hole H1.

In this manner, the area (projected area) of the protrusion of the joining pin SP1 viewed from the pass-through direction of the protrusion increases from the side in contact with the joining material PP toward the upper end of the protrusion of the joining pin SP1. In other words, the cross-sectional area of the protrusion of the joining pin SP1 cut along a plane perpendicular to the extending direction of the through hole H1 increases toward the upper end. That is, the protrusion of the joining pin SP1 has a reverse tapered shape as viewed from a direction perpendicular to the extending direction of the through hole H1.

As described above, the joining device 100 forms the protrusion of the joining pin SP1 in a reverse tapered shape so as to improve the load resistance, deformation resistance, durability against cracking, and the like to the joint 40.

The protrusion of the joining pin SP1 has, for example, a mortar shape as illustrated in FIG. 10. Alternatively, the protrusion of the joining pin SP1 may have a pan shape, a dish shape, or a round dish shape. Still alternatively, the protrusion of the joining pin SP1 may have a shape imitating a screw head shape such as a truss shape or a bind shape.

In addition, the joining device 100 may increase the tightening force by shaping the protrusion of the joining pin SP using a shaping material having high thermal shrinkage and then machining the protrusion into a flat shape. In addition, the joining device 100 may form the protrusion of the joining pin SP into the above screw head shape while pressing the protrusion of the joining pin SP against the joining material PP.

In addition, the joining device 100 may cause the protrusion of the joining pin SP to cut into the joining material PP outside the through hole H1. FIG. 11 is a diagram for explaining a second different shape example of the protrusion of the joining pin formed by the joining device according to the first embodiment. FIG. 11 illustrates a cross-sectional shape of the joining pin SP2 in which the protrusion cuts into the outer circumference of the through hole H1 of the joining material PP. Here, the protrusion of the joining pin SP2 is a fixed protrusion formed by machining of the joining pin SP.

Because the joining device 100 partially shields the shaping position from the atmosphere using the shield gas G to additively manufacture the joining pin SP, the joining pin SP has a strength at the forging strength level. Here, the joining device 100 applies pressure to a position outside the through hole H1 on the protrusion with a press machine or the like by utilizing the strength of the joining pin SP at the forging strength level. Then, the joining device 100 fits the joining material PP to the joining pin SP so that a part of the bottom surface of the protrusion cuts into the outer region of the joining material PP relative to the through hole H1. In this case, the outer region of the joining material PP relative to the through hole H1 may be recessed in advance so that the protrusion deformed by the pressure sticks in the joining material PP in a nail shape. That is, the joining material PP may include a recess in the outer region relative to the through hole H1. In this case, because the joining device 100 melts the protrusion with the heat source HS, the molten metal of the protrusion flows into the recess of the joining material PP. As a result, the joining system 101 does not need cut-in processing by press or the like.

As described above, in the joining device 100, because a recess is provided in the joining material PP in advance, the protrusion is fit to the recess at the time of machining the protrusion. As a result, the molten metal of the protrusion is fixed to the joining material PP in a nail shape, leading to high durability of the joint 40.

In addition, the joining device 100 may apply pressure to the facing surfaces of the materials to be joined by press molding to expose newly formed surfaces, and cause the materials to be joined to adhere to each other by performing interatomic bonding between the newly formed surfaces. In this case, the joining device 100 may cause the facing surfaces of the materials to be joined to expose newly formed surfaces in advance by laser processing. The joining device 100 can improve the degree of close contact and the joining strength between the joining pin SP and the joining material PP by applying pressure by means of press molding. In addition, the joining device 100 can increase durability against repeated fatigue to the joint 40.

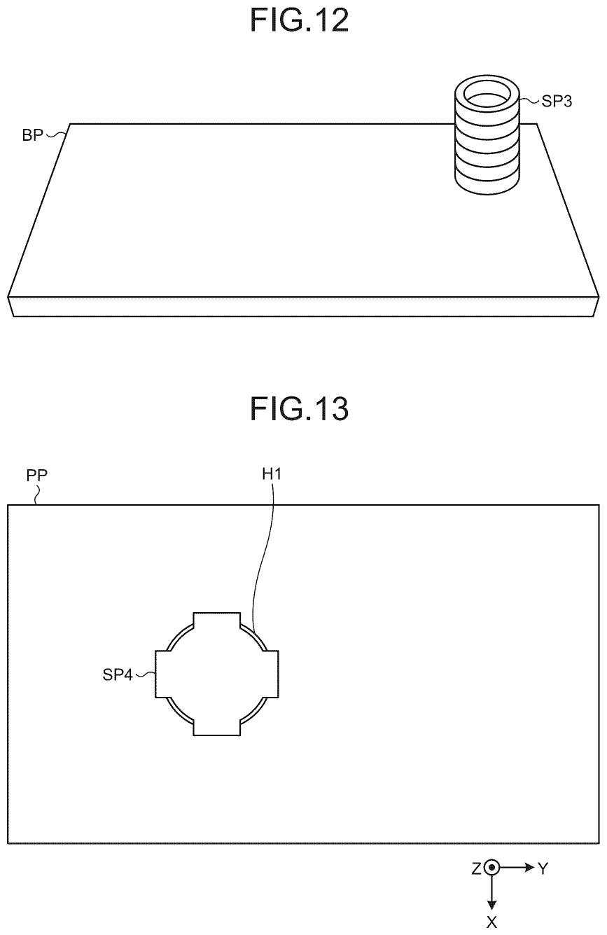

In addition, the joining device 100 may additively manufacture a joining pin SP3 having a hollow structure (hollow shape) inside as will be described below. FIG. 12 is a diagram for explaining a different shape example of the joining pin that is additively manufactured by the joining device according to the first embodiment. FIG. 12 illustrates the shape of the joining pin SP3 having a hollow structure inside.

The joining pin SP3 has a cylindrical shape with a hollow structure inside. That is, the joining pin SP3 has a hollow tube shape having a hollow portion inside. As a result, the weight of the joining pin SP3 can be reduced, and the torsional rigidity of the joining pin SP3 can be increased. Note that the cross-sectional shape of the joining pin SP3 cut along a plane perpendicular to the extending direction of the joining pin SP3 may be any shape such as a circular shape or a polygonal shape.

In addition, the joining device 100 may additively manufacture a joining pin SP4 sticking out from the through hole H1 at only a part of the outer circumferential portion as will be described below. FIG. 13 is a diagram for explaining a third different shape example of the protrusion of the joining pin that is additively manufactured by the joining device according to the first embodiment. FIG. 13 illustrates the upper surface shape of the joining pin SP4 sticking out from the through hole H1 at only a part of the outer circumferential portion. Here, the protrusion of the joining pin SP4 is a fixed protrusion formed by machining of the joining pin SP.

When the joining pin SP4 is viewed from above, only a part of the outer circumferential portion of the protrusion sticks out from the through hole H1, and the other part of the joining pin SP4 fits inside the region of the through hole H1. In other words, when the joining pin SP4 is viewed from above, a part of the outer circumferential shape of the protrusion of the joining pin SP4 sticks out from the through hole H1, and the other part fits inside the region of the outer circumferential shape of the through hole H1 on the upper surface of the joining material PP. In FIG. 13, the outer circumferential portion of the protrusion of the joining pin SP4 viewed from above is divided into eight regions, four of the eight regions stick out from the through hole H1, and the remaining four regions fit inside the region of the through hole H1.

The region of the protrusion sticking out from the through hole H1 may have any shape. The region of the protrusion sticking out from the through hole H1 has, for example, a rectangular shape. The region of the protrusion that fits inside the through hole H1 is a circular region smaller than the through hole H1, and a gap is provided between the through hole H1 and the joining pin SP4.

For example, the joining device 100 deforms the joining pin SP4 so that only a part of the protrusion sticks out from the hole cross section of the through hole H1, or adds a point shape to form the joining pin SP4 into a polygonal shape. As a result, it is possible to put a liquid or paste having an electrolytic corrosion preventing effect, such as grease or rust inhibitor (for example, anti-rust oil), into the gap generated between the joining pin SP4 and the joining material PP. In addition, it is possible to simplify the machining of the protrusion.

Although the joining base material BP described in the first embodiment has a plate shape, the joining base material BP is not limited to the plate shape. If the joining device 100 has a five-axis structure, the joining base material BP may have a complicated shape such as a curved surface or an uneven shape, and the machining head drive unit 71 can change the relative position between the joining base material BP and the machining head 6 based on the drive command DC. As a result, the joining device 100 can produce the object OP by additively manufacturing a required number of joining pins SP in any place of the joining base material BP if the machining head 6 can be brought to the shaping position. In addition, the joining material PP is not limited to the plate shape similarly to the joining base material BP.

As illustrated in FIG. 2, the emission port of the wire nozzle 80 is located away from the emission port of the heat source supply nozzle 14 on a plane parallel to the XY plane. The wire nozzle 80 causes the shaping material PM to travel in non-parallel to the heat source HS as the shaping material PM passes through the wire nozzle 80. The control unit 1 may change the angle between the supply direction of the wire nozzle 80 through which the wire-like shaping material PM passes and the supply direction of the heat source HS to control the traveling direction of the shaping material PM, the machining position to which the shaping material PM is added, and the like.

In the joining device 100, the wire nozzle 80 may be disposed coaxially with the heat source supply nozzle 14. In this case, for example, the outer shape of the wire nozzle 80, the outer shape of the gas nozzle 13, and the outer shape of the heat source supply nozzle 14 are set to the side surface shape of a truncated cone. For example, the wire nozzle 80 is disposed at the center, and the gas nozzle 13 and the heat source supply nozzle 14 are disposed surrounding the outside thereof. Alternatively, the heat source supply nozzle 14 may be disposed at the center, and a plurality of wire nozzles 80 may be disposed surrounding the outside thereof so that the scanning direction of the laser and the direction of supplying the shaping material PM can be set to the same direction. In addition, a plurality of ejection ports of the shaping material PM may be provided so that a plurality of different shaping materials PM can be fed from different ejection ports.

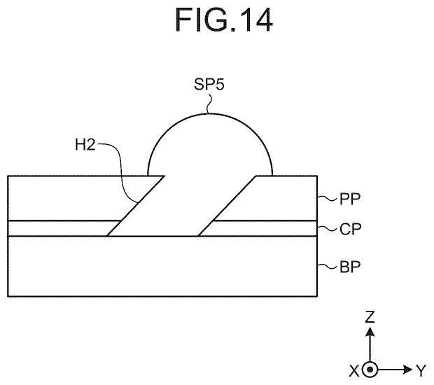

In addition, the joining device 100 may additively manufacture a joining pin SP5 inclined with respect to the Z axis direction as will be described below. FIG. 14 is a diagram for explaining a fourth different shape example of the protrusion of the joining pin that is additively manufactured by the joining device according to the first embodiment. FIG. 14 illustrates a cross-sectional shape of the joining pin SP5 inclined with respect to the Z-axis direction. Here, the protrusion of the joining pin SP5 is a fixed protrusion formed by machining of the joining pin SP.

The joining pin SP5 is not perpendicular to the upper surface of the joining material PP. That is, the joining pin SP5 extends in an inclined direction not parallel to the perpendicular to the upper surface of the joining material PP. In this case, a through hole H2 provided in the joining material PP also extends in a direction not perpendicular to the upper surface of the joining material PP. The inclination angle of the through hole H2 with respect to the Z-axis direction is the same as the inclination angle of the joining pin SP5 with respect to the Z-axis direction. The outer circumferential shape of the fixed protrusion of the joining pin SP5 viewed from the pass-through direction is larger than the outer circumferential shape of the protrusion outlet such as the through hole H2.

Thus, the joining device 100 can produce the joint 40 having a shape that can exhibit a strong resistance to the pull-out stress in the Z-axis direction, which is the vertical direction, by inclining the through hole H2 and the joining pin SP5 at the same ratio.

As described above, in the joining device 100 according to the first embodiment, if the joining pins SP, SP1 to SP5, and the like can be erected on the joining surface of an arbitrary curved surface, the joining base material BP and the joining material PP can be joined, so that the degree of freedom of the shape that can be joined is large.

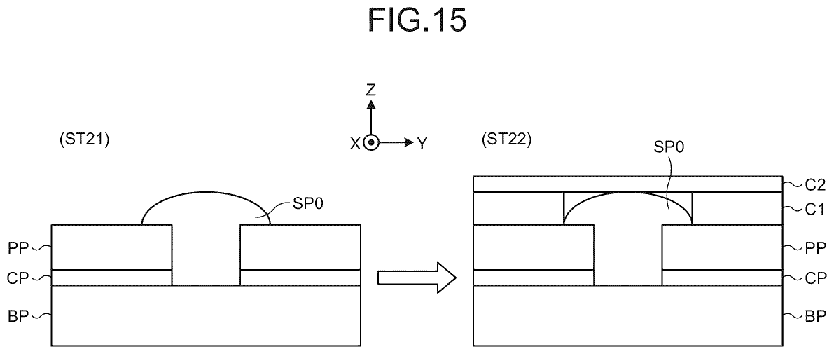

In addition, the joining device 100 may cover the periphery of the protrusion of the joining pin SP0 with a covering portion. FIG. 15 is a diagram for explaining the additive manufacturing process of a covering portion by the joining device according to the first embodiment. FIG. 15 illustrates a cross-sectional shape of the joining base material BP and the like.

The joining device 100 joins the joining base material BP and the joining material PP with the joining pin SP0 (ST21). Thereafter, the joining device 100 additively manufactures the periphery of the protrusion of the joining pin SP0 with a wire of the same material (second shaping material) as the joining material PP to cover the protrusion (ST22). Specifically, the joining device 100 supplies the shaping material and the heat source for heating to a specific region of the joining material PP to additively manufacture a covering portion C1 surrounding the side surface of the protrusion.

Furthermore, the joining device 100 supplies the shaping material and the heat source for heating to a specific region of the joining material PP to additively manufacture a covering portion C2 covering the upper surfaces of the covering portion C1 and the protrusion.

The covering portion C1 is an additively manufactured object disposed on the upper surface of the joining material PP, and the covering portion C2 is an additively manufactured object disposed above the covering portion C1. The covering portion C1 has an annular upper surface region when the covering portion C1 is viewed from above. The covering portion C2 has a circular upper surface region when the covering portion C2 is viewed from above. The joining device 100 additively manufactures the covering portion C1 such that the joining pin SP0 fits inside the annular region of the covering portion C1. In addition, the joining device 100 additively manufactures the covering portion C2 such that the joining pin SP0 and the covering portion C1 fit inside the circular region of the covering portion C2. The covering portions C1 and C2 are additively manufactured objects formed of the second shaping material.

As described above, because the joining device 100 covers the protrusion of the joining pin SP0 with the covering portions C1 and C2, it is possible to prevent the interface of the dissimilar metals from being exposed to the atmosphere and to prevent the joining pin SP0 from coming into contact with moisture. Therefore, the joining device 100 can improve the environmental resistance of the joint 40 at which the joining base material BP and the joining material PP are joined.

Note that the shaping material that the joining device 100 uses to cover the joining pin SP0 need not necessarily be the same material as the joining material PP as long as the shaping material can be welded or additively manufactured on the joining material PP. That is, the shaping material for use in the additive manufacturing of the covering portions C1 and C2 may be the same as or different from the shaping material PM described above. In addition, the shaping material for use in the additive manufacturing of the covering portion C1 may be the same as or different from the shaping material for use in the additive manufacturing of the covering portion C2. In addition, the shaping material for use in covering by the joining device 100 is not limited to wire, and may be other forms of materials such as powder and paste.

As described above, the joining method according to the first embodiment includes an additive manufacturing step in which the joining device 100 performs additive manufacturing of the joining pin SP in the machining region of the joining base material BP by means of material supply for supplying the shaping material PM to the machining region, and by means of heating and melting for supplying the heat source HS to the machining region to melt the shaping material PM.

In addition, the joining method according to the first embodiment includes a disposing step in which the joining device 100 disposes the joining material PP and the joining base material BP such that the joining pin SP or the like passes through the through hole H1 or the like of the joining material PP and protrudes from the through hole H1 or the like.

In addition, the joining method according to the first embodiment includes a machining step in which the joining device 100 forms a fixed protrusion that fixes the joining material PP and the joining base material BP by machining a protrusion that is a portion of the joining pin SP or the like protruding from the through hole H1 or the like. In the joining method according to the first embodiment, the outer circumferential shape of the fixed protrusion viewed from the pass-through direction is larger than the outer circumferential shape of the outlet of the through hole H1 or the like from which the protrusion protrudes.

Here, joining methods of comparative examples will be described. The joining method of Comparative Example 1 is a method of joining a surface plate having a pilot hole and an additive manufacturing model having a snap-fit structure. With the joining method of Comparative Example 1, the surface plate and the additive manufacturing model are joined by fitting the snap-fit structure into the pilot hole.

In the joining method of Comparative Example 1, because it is necessary to deform the nail portion when the snap-fit structure is fit into the pilot hole, the snap-fit structure needs to have deflection. Therefore, the tensile strength of the snap-fit structure is lowered by the amount of deformation of the nail portion. In addition, in the joining method of Comparative Example 1, because the load is received only by the nail having an elastic portion, the strength and the load resistance are low.

Snap-fit structures are often applied to resins but may be exceptionally used with metal, in which snaps or keyholes are often produced by sheet-metal processing. In many cases where snaps are formed, a single plate is partially folded back in order to ensure a spring property, and a complicated structure cannot be formed. Therefore, with the joining method of Comparative Example 1, it is difficult to ensure the load resistance. In addition, in many cases where the metal side is a keyhole, the nail portion is made of resin to secure deformation tolerance for fitting, and the load resistance is further lowered.

In addition, the joining method of Comparative Example 1 requires a gap for fitting at the interface between the joining targets, causing large rattling. Therefore, if the snap-fit structure is used in a place subject to frequent changes in force, abrasion due to wear of the nail portion, enlargement of the keyhole portion, and the like occur, and rattling increases with time. Therefore, the joining method of Comparative Example 1 is not suitable for use in joint portions to which stress is repeatedly applied or joint portions that require high strength.

From the viewpoint of shaping, only resin can implement snap-fit structures in stereolithography. In the case of metal, production with Powder Bed Fusion (PBF) takes a very long time. In addition, in the case of metal, it is difficult with Binder Jetting (BJT) and Material Extrusion (MEX) to design the nail portion by consideration of the shrinkage phenomenon in the shaped portion due to sintering. In addition, PBF, BJT, and MEX are basically methods of production from scratch, and it is difficult to form additional deposits on the joining base material or the like in terms of setup and deposition type.

In addition, even in the case of using DED, which allows for additional deposition, cutting finish in post-processing is essential for creating a highly accurate nail structure, and it takes a long time to create the nail structure.

Therefore, for implementing snap-fit structures with metal, simple shapes such as sheet metals are adopted, or shaving processes are adopted. The adoption of simple shapes such as sheet metals is not appropriate from the viewpoint of strength as described above. The adoption of shaving processes is not appropriate because of a large amount of shaving waste and a long machining time for the portion to be shaved and discarded.

With the joining method of Comparative Example 2, a T-shaped button component made of steel is inserted from the upper plate surface of a stack material formed of an aluminum plate as an upper plate and a steel plate as a lower plate until the end of the button component comes into contact with the surface of the lower plate, and the end of the button component and the surface of the lower plate are welded and joined by spot welding.

The joining method of Comparative Example 2 has restrictions on joining conditions and shapes for joining dissimilar materials. In addition, spot welding is essential for the joining method of Comparative Example 2. For this reason, in the case of the joining method of Comparative Example 2, depending on the combination of electrodes, currents, and materials, brittle intermetallic compounds may be mixed into the interface where the button component is in contact with the aluminum plate, reducing the strength of the joint portion. In addition, in order to deal with changes in material or the thickness of the material to be joined, it is essential to produce dedicated button components. For this reason, it takes time and effort to manufacture and procure components.

In the spot welding, it is necessary to hold the portion to be welded with a spot welding gun from above and below; therefore, there are restrictions on the thickness of the base material, and welding is supposed to be performed between parts of the same material. In addition, even if welding of dissimilar materials can be implemented by spot welding, corrosion called electrolytic corrosion is likely to occur due to the contact between the dissimilar metals, so that treatment for preventing electrolytic corrosion is required. In addition, an attempt to insulate the dissimilar materials for preventing electrolytic corrosion results in a difficulty to implement the spot welding itself, in which the dissimilar materials are welded by means of energization.

With the joining method of Comparative Example 3, the lower plate is made of an aluminum alloy, a hole is formed along a welding line in the steel plate of the upper plate which is a lap joint, and Metal Inert Gas (MIG) welding is performed from above the steel plate using an aluminum alloy wire to obtain fusion penetration of the aluminum alloy of the lower plate through the hole of the steel plate. Thus, the aluminum alloy of the lower plate and the steel plate are joined via the hole.

In the joining method of Comparative Example 3, because the difference in melting point between the two types of materials is used to prevent intermetallic compounds, the aluminum alloy is melted by performing MIG welding with a current that does not melt the steel. Therefore, the materials that can be joined are limited to combinations of materials having a large difference in melting point between dissimilar materials, such as steel and an aluminum alloy. In addition, the material for making the rivet by performing melting in MIG welding is inevitably limited to the material on the lower melting point side. In addition, the strength of the rivet-like portion produced by MIG welding is the casting strength level, which is weak.

In the joining method of Comparative Example 3 with which molten metal is poured into the hole to erect a pin, the strength of the pin is the casting strength level. On the other hand, in the first embodiment, the joining pin SP and the like which are additively manufactured by the joining device 100 can be additively manufactured with a strength at the forging strength level, and have high strength.

In addition, with the joining method using rivets, it is not possible to join arbitrary shapes due to the thickness limit, restriction of nugget formation, and the like. Specifically, if the adjacent rivet is too close, the current flowing at the time of spot welding is divided, resulting in insufficient nugget formation. Furthermore, because point joining is used in principle, fatigue properties are inferior to those of contact joining such as adhesion.

In addition, normal blind rivets are subject to electrolytic corrosion unless the same substance as the base material is selected as the rivet, and thus the substance of the rivet that can be used is limited. In addition, although there is a demand for using the joint 40 in a humid environment or in an aqueous solution, most rivets are made of stainless steel, iron, aluminum, or resin, and almost no other substance exists.

In the joining device 100 according to the first embodiment, the joining pin SP is additively manufactured on the joining base material BP, and the joining pin SP passes through the through hole H1 of the joining material PP. Then, the joining device 100 joins the joining material PP to the joining base material BP by making the area of the protrusion larger than the area of the upper surface of the through hole H1 or the like.

As a result, the joining device 100 can implement joining that achieves high tensile strength, high load resistance, and small rattling. In addition, the joining device 100 can also implement joining on joint portions to which stress is repeatedly applied or joint portions that require high strength.

In addition, because the joining device 100 additively manufactures the joining pin SP, it is easy to design, set up, and produce the joining pin SP, and the joining pin SP can be produced in a short time. In addition, the joining device 100 can significantly reduce the amount of waste of the base material and the machining time as compared with the case where a connection member is formed by cutting and shaving.

In addition, because the joining device 100 additively manufactures the joining pins SP, the thickness and the interval of the joining pins SP can be freely set, and there is no influence of defective nugget formation and the like due to the close interval that may occur in rivet welding while the adjacent joining pins SP are shaped. Therefore, the joining device 100 can implement joining that ensures high strength. In addition, because the joining device 100 does not require mechanical fastening elements such as bolts and rivets, it is possible to achieve weight reduction and resource saving of the joint 40 while ensuring high strength.

In addition, the joining executed by the joining device 100 does not have limitations on the shapes and types of members to be machined, such as joining between columns and between steel plates, as compared with friction stir welding. That is, because the joining device 100 joins the joining base material BP and the joining material PP, which are the materials to be joined (structures), using the additively manufactured joining pin SP, it is possible to join the materials to be joined having various materials or shapes.

In friction stir welding, frictional heat is generated by bringing a cylindrical tool called a tool having a protrusion at the tip into contact with the base material and applying pressure while rotating the tool. In friction stir welding, it is necessary to cause the protrusion of the tool to penetrate in the solid phase into the welding portion of the base material softened by frictional heat, and the shape into and through which the tip of the tool can move is limited to plate materials having a simple shape. Another method of friction stir welding is to perform welding by generating frictional heat using the rotation difference between base materials without using a tool. In this case, however, because it is necessary to rotate the base materials, there is an inevitable limitation to cylindrical materials or columnar materials having the same central axis. In addition, large materials require a large lathe, which makes machining difficult. On the other hand, the joining device 100 only needs to be able to cause the machining head 6 attached to the end of the robot arm or the like to reach the machining position, and can perform joining without being affected by the size of the base material.

There is also a joining method using an adhesive such as an epoxy resin. The joining method using an adhesive is inferior in peeling strength (force perpendicular to the adhesive surface), that is, stress concentrated at one point. This is because the adhesive surface cannot gain strength, and it is difficult for the adhesive to exhibit strength to a narrow portion where the area of the adhesive surface is insufficient. In addition, the joining method using an adhesive is weak against temperature changes. On the other hand, the joining device 100 does not use an adhesive, and thus can perform firm joining even between the materials to be joined with a small joining surface area. In addition, because the joining device 100 does not use an adhesive, it is possible to perform strong joining resistant to temperature changes.

In addition, the adhesive force tends to vary depending on the coating film thickness, peripheral conditions at the time of curing, work level, and the like, and it is also difficult to determine the quality of adhesion after machining. Non-destructive inspection for quality determination can use infrared rays, sound waves, and the like, with which qualitative determination is possible but quantitative determination is difficult. On the other hand, the joining device 100 can improve the shaping reproducibility of the strength of the joining pin SP by fixing the additive manufacturing conditions, and internal inspection for quality determination can be easily made using X-ray inspection, composition analysis, or the like.

In addition, it is difficult for any of the joining methods of Comparative Examples 1 to 3 to implement joining on multilayer structures of three or more layers. On the other hand, the joining device 100 performs joining using the additively manufactured joining pin SP, and thus can easily perform joining even on multilayer structures of three or more layers.

Note that the joining process described in the first embodiment may be performed by a worker at a remote location away from the place where the heat source supply unit 2, the gas supply unit 4, the shaping material supply unit 8, and the like are disposed. That is, the joining device 100 may execute the joining of the joining base material BP and the joining material PP in accordance with an instruction from a worker at a remote location. In addition, the joining device 100 may produce a joining pin that is a combination of shapes of the joining pins SP and SP1 to SP5.

As described above, in the first embodiment, the joining device 100 additively manufactures the joining pin SP on the joining base material BP, passes the joining pin SP through the through hole H1 of the joining material PP, and machines the protrusion of the joining pin SP. In this case, the joining device 100 fixes the joining base material BP and the joining material PP by machining the protrusion such that the outer circumferential shape of the protrusion viewed from the pass-through direction is larger than the outer circumferential shape of the outlet of the through hole H1 from which the protrusion protrudes. As a result, the joining device 100 can firmly join the joining base material BP which is a material to be joined and the joining material PP which is a material to be joined.

### Second Embodiment

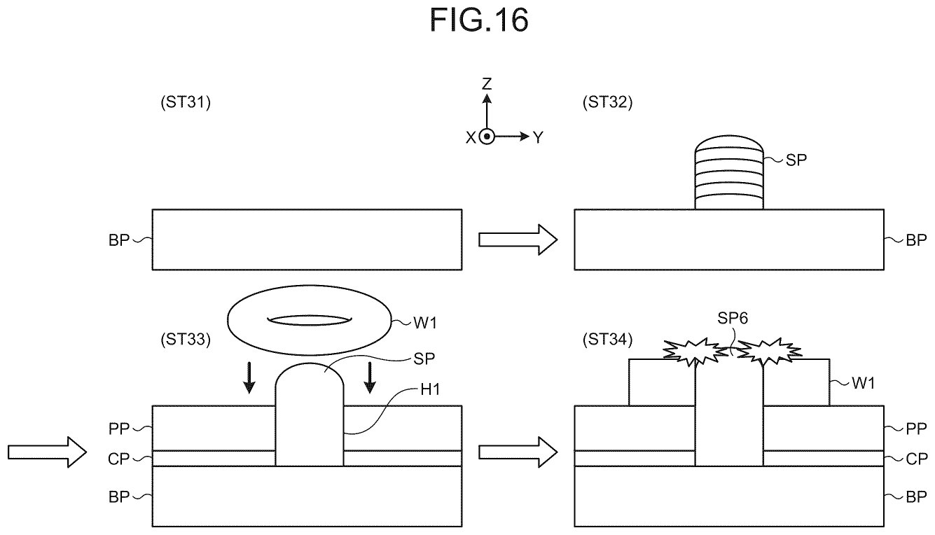

Next, the second embodiment will be described with reference to FIG. 16. In the second embodiment, the joining device 100 disposes an annular spacer to be joined to the joining pin SP on the joining material PP, and joins the spacer and the joining pin SP.

The configuration of the joining device 100 in the second embodiment is the same as that of the joining device 100 in the first embodiment. In addition, the joining device 100 according to the second embodiment joins the joining base material BP and the joining material PP in a procedure similar to that of the joining device 100 according to the first embodiment described with reference to FIG. 7. The second embodiment is different from the first embodiment in the member for use in joining. Hereinafter, the joining process by the joining device 100 according to the second embodiment will be described.

FIG. 16 is a diagram for explaining the joining process by the joining device according to the second embodiment. FIG. 16 illustrates a cross-sectional shape of the joining base material BP and the like. In FIG. 16, a spacer W1 is illustrated in perspective view.

The steps in which the joining device 100 forms the joining pin SP on the joining base material BP and passes the joining pin SP through the through hole H1 of the joining material PP to dispose the joining material PP on the joining base material BP are the same as those in the first embodiment.

That is, the joining device 100 conveys the joining base material BP to the stage 10 by means of the conveyance unit 30, and fixes the joining base material BP to the stage 10 (ST31). Then, the joining device 100 additively manufactures the joining pin SP on the upper surface of the joining base material BP (ST32).

The joining device 100 may or may not sandwich the anti-electrolytic-corrosion sheet CP between the joining base material BP and the joining material PP depending on the necessity. In addition, the joining device 100 may fill the gap provided between the joining base material BP and the joining material PP in advance by brazing with a material different from both the joining base material BP and the joining material PP.

After additively manufacturing the joining pin SP, the joining device 100 conveys the joining material PP to the stage 10 by means of the conveyance unit 30. Then, the conveyance unit 30 passes the joining pin SP through the through hole H1 of the joining material PP. As a result, the conveyance unit 30 disposes the joining material PP on the upper surface of the joining base material BP.

Next, the joining device 100 disposes an annular member such as the spacer W1 surrounding the side surface of the protrusion at a position where the protrusion of the joining pin SP is disposed on the upper surface of the joining material PP. Specifically, the joining device 100 disposes the spacer W1 made of the same material as the joining pin SP by means of the conveyance unit 30 in a region surrounding the protrusion of the joining pin SP projecting from the joining material PP.

The spacer W1 has a hole with a hole diameter (inner diameter) equal to or larger than the outer diameter of the joining pin SP, and the spacer W1 is disposed surrounding the protrusion of the joining pin SP. The spacer W1 is an annular member having an annular upper surface region when the spacer W1 is viewed from above. The joining device 100 disposes the spacer W1 on the upper surface of the joining material PP such that the joining pin SP fits inside the annular region of the spacer W1. In FIG. 16, a state in which the spacer W1 is disposed at the position of the protrusion of the joining pin SP is illustrated as (ST33).

Thereafter, the joining device 100 moves the machining head 6 to the gap between the spacer W1 and the protrusion of the joining pin SP by means of the machining head drive unit 71. Then, the joining device 100 feeds the shaping material PM from the wire nozzle 80 into the gap, and outputs the heat source HS to the gap to melt the shaping material PM. Accordingly, the joining device 100 joins the spacer W1 and the joining pin SP by performing fusion penetration between the spacer W1 and the joining pin SP. That is, the joining device 100 joins the spacer W1 and the joining pin SP by filling the gap between the spacer W1 and the protrusion of the joining pin SP with the melted shaping material PM. At this time, the joining device 100 fills the gap between the spacer W1 and the protrusion of the joining pin SP while causing the machining head 6 to circle along the gap. As a result, the member including the joining pin SP and the spacer W1 turns to a joining pin SP6. In FIG. 16, a state in which the protrusion of the joining pin SP is melted with the heat source HS into the joining pin SP6 is illustrated as (ST34). Here, the protrusion of the joining pin SP6 is a fixed protrusion formed by machining of the joining pin SP. Note that the shape of the joining pin SP6 is not limited to the shape illustrated in FIG. 16, and may be any of the shapes described in the first embodiment.

The joining device 100 may perform joining by line shaping or by point shaping. In the case of joining by point shaping, the joining device 100 may perform circling radiation of only the heat source HS after completion of circling to remelt and smooth the point shaping surface. Consequently, the joining device 100 can increase the surface accuracy of the point shaping portion.

The joining method according to the second embodiment enables the joining device 100 to easily produce the flat shape of the protrusion even when the joining pin SP is made of a material that is difficult to remelt due to the high heat dissipation associated with the good thermal conductivity of the shaping material PM.

In addition, by producing or procuring the spacer W1 in advance, the joining device 100 can shorten the machining time for producing the flat shape. In addition, because the joining device 100 uses the spacer W1, the area of the joining material PP sandwiched between the spacer W1 and the joining base material BP can be easily enlarged.

In addition, the joining device 100 may make the hole diameter of the spacer W1 and the outer diameter of the joining pin SP substantially the same, and may join the spacer W1 and the joining pin SP by mutually melting the spacer W1 and the joining pin SP just by radiation of the heat source HS. In this case, the joining device 100 does not need to consume the shaping material PM to fill the gap. In addition, because the joining device 100 only needs to radiate just the heat source HS along the gap from the machining head 6 located remotely from the location of the spacer W1, the handling of the machining head 6 can be simplified.

In addition, the joining device 100 can also produce the shape of the joining pin SP2 illustrated in FIG. 11 by joining the spacer W1 and the joining pin SP and then pressing the spacer W1 from just above so as to increase the joining strength. In addition, a recess may be formed in advance by grooving on the joining material PP, and the shape of the joining pin SP2 illustrated in FIG. 11 may be produced by the joining device 100 melting the spacer W1 by means of the heat source HS in a state that the spacer W1 fits with the groove and the joining pin SP. As a result, the spacer W1 is fit to the recess. Producing the shape of the joining pin SP2 leads to high durability of the joint 40.

### Third Embodiment

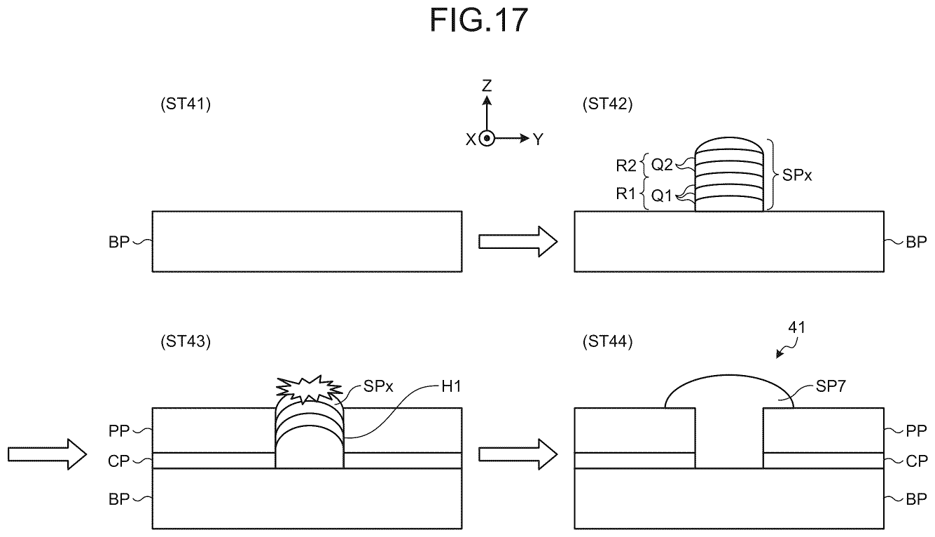

Next, the third embodiment will be described with reference to FIG. 17. In the third embodiment, the joining device 100 additively manufactures a joining pin using a plurality of types of shaping materials.

The configuration of the joining device 100 in the third embodiment is the same as that of the joining device 100 in the first embodiment. In addition, the joining device 100 according to the third embodiment joins the joining base material BP and the joining material PP in a procedure similar to that of the joining device 100 according to the first embodiment described with reference to FIG. 7. The third embodiment is different from the first embodiment in the method of producing a joining pin. Hereinafter, the joining process by the joining device 100 according to the third embodiment will be described.

FIG. 17 is a diagram for explaining the joining process by the joining device according to the third embodiment. FIG. 17 illustrates a cross-sectional shape of the joining base material BP and the like. The joining device 100 conveys the joining base material BP to the stage 10 by means of the conveyance unit 30, and fixes the joining base material BP to the stage 10 (ST41). Then, the joining device 100 additively manufactures a joining pin SPx on the upper surface of the joining base material BP (ST42). Specifically, the joining device 100 moves the machining head 6 to a position on the joining base material BP where the joining pin SPx is erected. In addition, the joining device 100 feeds the shaping material PM from the wire nozzle 80 to the producing position of the joining pin SPx. In addition, the joining device 100 outputs the heat source HS to the producing position of the joining pin SPx. Consequently, the joining device 100 melts the shaping material PM fed from the wire nozzle 80 of the machining head 6 to the producing position of the joining pin SPx. The joining device 100 solidifies the melted shaping material PM into a hemispherical projection by utilizing the surface tension of the molten metal on the joining base material BP, and forms a pin layer Q1 having a height of one pitch of deposition. This pin layer Q1 is the first deposit constituting the joining pin SPx.

Next, the machining head drive unit 71 moves the machining head 6 to the shaping position higher by one pitch of deposition. The joining device 100 melts the shaping material PM just above the projection, that is, just above the formed pin layer Q1, by outputting the heat source HS in the same manner as in the first pin layer Q1. The joining device 100 solidifies the melted shaping material PM on the pin layer Q1, which is a projection, to form a new pin layer Q1 having a height of one pitch of deposition. The joining device 100 repeats this deposition a plurality of times to produce a pin portion R1 consisting of a plurality of pin layers Q1. The pin portion R1 is an additively manufactured object formed by hemispherical projections deposited in a plurality of stages. Note that the pin portion R1 may be the pin layer Q1 of only one pitch of deposition.

Next, the machining head drive unit 71 moves the machining head 6 to the shaping position higher by one pitch of deposition. In addition, the joining device 100 changes the wire spool 81 to another wire spool that stores a wire of a shaping material (hereinafter referred to as the shaping material PMx) made of a substance different from that of the shaping material PM.

The joining device 100 feeds the shaping material PMx from the wire nozzle 80 of the machining head 6 onto the pin portion R1. In addition, the joining device 100 outputs the heat source HS to the producing position of the joining pin SPx. Consequently, the joining device 100 melts the shaping material PMx fed from the wire nozzle 80 of the machining head 6 to the producing position of the joining pin SPx. The joining device 100 solidifies the melted shaping material PMx into a hemispherical projection by utilizing the surface tension of the molten metal, and forms a pin layer Q2 having a height of one pitch of deposition.

The joining device 100 repeats the additive manufacturing of the pin layer Q2 a plurality of times in the same manner as in the pin layer Q1 to produce a pin portion R2 consisting of a plurality of pin layers Q2. The pin portion R2 is a hemispherical projection in a plurality of stages. Note that the pin portion R2 may be the pin layer Q2 of only one pitch of deposition. The pin portion R1 and the pin portion R2 are made of different substances and have different mechanical properties. That is, the joining pin SPx configured by the pin portion R1 and the pin portion R2 is a graded material. Graded materials are also set called functionally graded materials (FGMs). In the case where the joining pin SPx is a graded material, the joining pin SPx is a structural material made of a plurality of materials having different compositions and integrally combined such that the spatial distribution of the compositions changes continuously or stepwise. In this manner, the joining device 100 can achieve conflicting, different properties by integrating a plurality of different materials. The spatial distribution of the compositions of the joining pin SPx can take various scales (such as nano, micro, meso, and macro).

The shaping material PMx may be the same as or different from the shaping material PM described above. In addition, the shaping material PMx may be the same as or different from the shaping material for use in the additive manufacturing of the covering portions C1 and C2 described above.

In this manner, the joining device 100 forms the joining pin SPx by forming the pin portion R2 on the upper side of the pin portion R1. The joining device 100 shapes the joining pin SPx such that the height of the joining pin SPx consisting of the pin portion R1 and the pin portion R2 is higher than the height of the joining material PP. The joining device 100 may change the ratio of the height of the pin portion R1 and the pin portion R2 according to the weight or rigidity required for the joining pin SPx. The pin portion R1 is a first pin portion, and the pin portion R2 is a second pin portion.

After shaping the joining pin SPx, the joining device 100 conveys the joining material PP to the stage 10 by means of the conveyance unit 30. The conveyance unit 30 disposes the joining material PP on the upper surface of the joining base material BP such that the joining pin SPx shaped on the joining base material BP passes through the through hole H1 of the joining material PP. That is, the conveyance unit 30 passes the joining pin SPx through the through hole H1 of the joining material PP. As a result, the head portion of the joining pin SPx passes through the through hole H1 and protrudes from the through hole H1 as a protrusion.

Thereafter, the joining device 100 starts joining the joining base material BP and the joining material PP. Specifically, the joining device 100 performs swaging in which the protrusion of the joining pin SPx protruding on the joining material PP is melted with the heat source HS and deformed into a flat shape. In FIG. 17, a state in which the protrusion of the joining pin SPx is melted with the heat source HS is illustrated as (ST43).

The joining device 100 expands the protrusion of the joining pin SPx by swaging that deforms the protrusion of the joining pin SPx. The joining pin SPx in which the protrusion is expanded is a joining pin SP7. As a result, the joining device 100 produces a joint 41 at which the joining base material BP and the joining material PP are joined. In FIG. 17, a state of the joint 41 at which the joining base material BP and the joining material PP are joined by the joining pin SP7 having the expanded protrusion is illustrated as (ST44). Here, the protrusion of the joining pin SP7 is a fixed protrusion formed by machining of the joining pin SPx.

Note that the joining device 100 may swage the protrusion of the joining pin SPx by performing deformation processing with physical impact using a hammer, a swaging tool, or the like, or by using other plastic processing means such as press.

The joining device 100 may or may not sandwich the anti-electrolytic-corrosion sheet CP between the joining base material BP and the joining material PP depending on the necessity. In addition, the joining device 100 may fill the gap provided between the joining base material BP and the joining material PP in advance by brazing with a material different from both the joining base material BP and the joining material PP. The shape of the joining pins SPx and SP7 is not limited to the shape illustrated in FIG. 17, and may be any of the shapes described in the first and second embodiments.

In addition, the combination of shaping materials is not limited to the two types of patterns described in the third embodiment, and may be the combination of the shaping material PM and the same material as the joining material PP. In addition, the joining device 100 may produce the joining pin SPx using three or more types of shaping materials.

In addition, the joining device 100 can use powder as shaping materials to produce the joining pin SPx while continuously changing the mixing ratio of a plurality of metal powder materials. As a result, the joining device 100 can produce the joining pin SPx in which the mechanical properties having the properties of the plurality of shaping materials are continuously changed, and can perform joining using the joining pin SPx.

Note that the joining device 100 may use wire, not powder, as shaping materials, and simultaneously put a plurality of wires into the producing position to produce the joining pin SPx while continuously changing the mixing ratio of a plurality of shaping materials.

As described above, according to the third embodiment, the joining device 100 can produce the joining pin SPx by combining different shaping materials PM and PMx when producing the joining pin SP7. As a result, the joining device 100 can easily produce the appropriate joining pin SPx according to the required weight or rigidity. Therefore, the joining device 100 can join the joining base material BP and the joining material PP by means of the appropriate joining pin SPx according to the required weight or rigidity.

### Fourth Embodiment

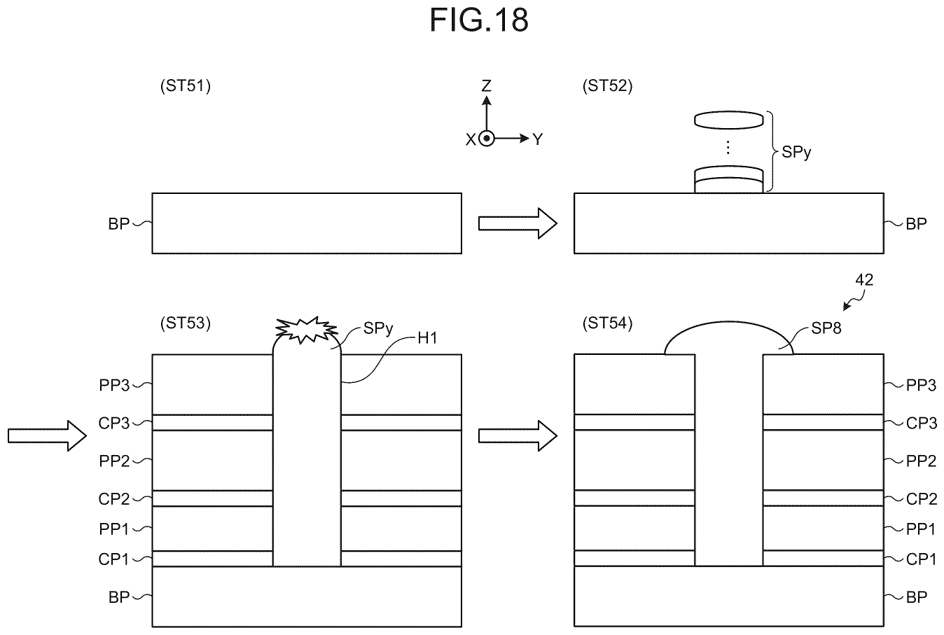

Next, the fourth embodiment will be described with reference to FIG. 18. In the fourth embodiment, the joining device 100 joins a plurality of layers of joining materials to the joining base material BP using a joining pin.

The configuration of the joining device 100 in the fourth embodiment is the same as that of the joining device 100 in the first embodiment. In addition, the joining device 100 according to the fourth embodiment joins the joining base material BP and joining materials (joining materials PP1 to PP3 to be described later) in a procedure similar to that of the joining device 100 according to the first embodiment described with reference to FIG. 7. The fourth embodiment is different from the first embodiment in the joining materials to be joined. Hereinafter, the joining process by the joining device 100 according to the fourth embodiment will be described.

FIG. 18 is a diagram for explaining the joining process by the joining device according to the fourth embodiment. FIG. 18 illustrates a cross-sectional shape of the joining base material BP and the like. The fourth embodiment describes a case where the three joining materials PP1 to PP3 are joined to the joining base material BP, but the number of joining materials joined to the joining base material BP may be two or may be four or more.

The joining device 100 conveys the joining base material BP to the stage 10 by means of the conveyance unit 30, and fixes the joining base material BP with the stage 10 (ST51). Then, the joining device 100 additively manufactures a joining pin SPy on the upper surface of the joining base material BP (ST52). Specifically, the joining device 100 additively manufactures the joining pin SPy on the joining base material BP so as to be higher than the total height of the joining targets, namely the joining materials PP1 to PP3 and anti-electrolytic-corrosion sheets CP1 to CP3. As in the process described in the first embodiment, the joining device 100 repeats the addition of one pitch of deposition to additively manufacture the joining pin SPy.

In the fourth embodiment, the joining targets are the joining materials PP1 to PP3 and the anti-electrolytic-corrosion sheets CP1 to CP3. The conveyance unit 30 stacks the joining base material BP, the anti-electrolytic-corrosion sheet CP1, the joining material PP1, the anti-electrolytic-corrosion sheet CP2, the joining material PP2, the anti-electrolytic-corrosion sheet CP3, and the joining material PP3 in this order from the bottom.

The through hole H1 similar to that in the joining material PP and the anti-electrolytic-corrosion sheet CP is formed with a drill or the like in the joining materials PP1 to PP3 and the anti-electrolytic-corrosion sheets CP1 to CP3. The conveyance unit 30 disposes the joining materials PP1 to PP3 and the anti-electrolytic-corrosion sheets CP1 to CP3 on the upper surface of the joining base material BP such that the joining pin SPy shaped on the joining base material BP passes through the through hole H1 of the joining materials PP1 to PP3 and the anti-electrolytic-corrosion sheets CP1 to CP3. That is, the conveyance unit 30 passes the joining pin SPy through the through hole H1 of the joining materials PP1 to PP3 and the anti-electrolytic-corrosion sheets CP1 to CP3. As a result, the head portion of the joining pin SPy passes through the through hole H1 and protrudes from the through hole H1 as a protrusion.

After passing the joining pin SPy through the through hole H1 of the joining materials PP1 to PP3 and the anti-electrolytic-corrosion sheets CP1 to CP3, the joining device 100 deforms the protrusion of the joining pin SPy into a flat shape by performing a process similar to the process described in the first embodiment. That is, the joining device 100 performs swaging in which the protrusion of the joining pin SPy is melted and deformed with the heat source HS. In FIG. 18, a state in which the protrusion of the joining pin SPy is melted with the heat source HS is illustrated as (ST53).

The joining device 100 expands the protrusion of the joining pin SPy by performing swaging that deforms the protrusion of the joining pin SPy. The joining pin SPy having the expanded protrusion is a joining pin SP8. As a result, the joining device 100 produces a joint 42 at which the joining base material BP and the joining materials PP1 to PP3 are joined. In FIG. 18, a state of the joint 42 in which the joining base material BP and the joining materials PP1 to PP3 are joined by the joining pin SP8 having the expanded protrusion is illustrated as (ST54). Here, the protrusion of the joining pin SP8 is a fixed protrusion formed by machining of the joining pin SPy.

Note that the shapes of the joining pins SPy and SP8 are not limited to the shape illustrated in FIG. 18, and may be any of the shapes described in the first to third embodiments.

In addition, the joining device 100 need not necessarily sandwich the anti-electrolytic-corrosion sheets CP1 to CP3. In addition, the joining device 100 may fill the gaps on the bottom surface side of the joining materials PP1 to PP3 by brazing. In this case, the joining device 100 brazes the gap between the joining base material BP and the joining material PP1 with a material different from both the joining base material BP and the joining material PP1. Similarly, the joining device 100 brazes the gap between the joining materials PP1 and PP2 with a material different from both the joining materials PP1 and PP2. Similarly, the joining device 100 brazes the gap between the joining materials PP2 and PP3 with a material different from both the joining materials PP2 and PP3.

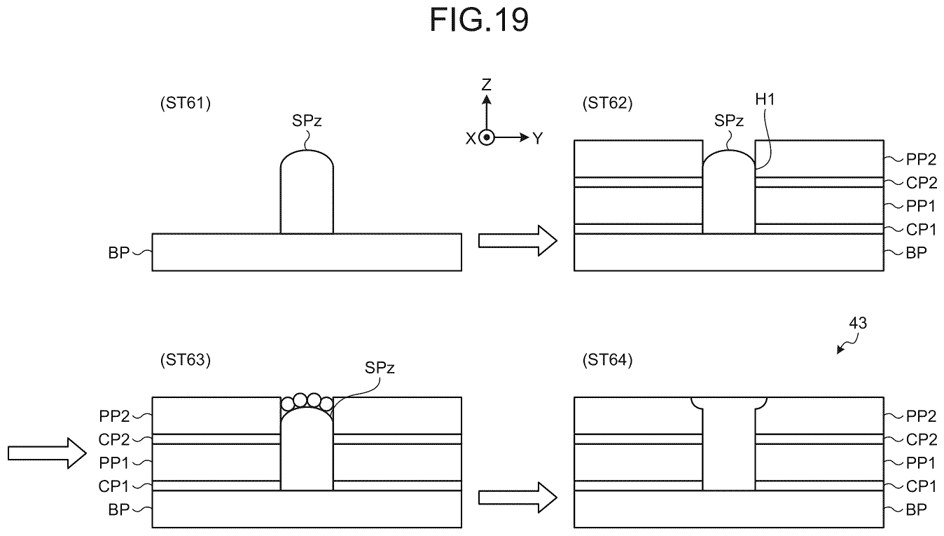

Next, a method in which the joining device 100 performs joining without using a protrusion will be described with reference to FIG. 19. FIG. 19 is a diagram for explaining the joining process by the joining device without using a protrusion according to the fourth embodiment. FIG. 19 illustrates a cross-sectional shape of the joining base material BP and the like. When the joining device 100 does not use a protrusion, the joining base material BP, a joining pin SPz, and the joining material PP2 are made of the same material or materials that are similar in physical properties such as melting point.

The joining device 100 conveys the joining base material BP to the stage 10 by means of the conveyance unit 30, and fixes the joining base material BP to the stage 10. Then, the joining device 100 additively manufactures the joining pin SPz on the joining base material BP to a height lower than the position to be the upper surface position (non-contact surface) of the joining material PP2 (ST61). Alternatively, the joining device 100 may additively manufacture the joining pin SPZ to a position higher than the joining material PP2, and then cut the joining pin SPz using the heat source HS such that the joining pin SPz has a height lower than the position to be the upper surface position of the joining material PP2, or the joining pin SPz may be separately cut by a cutting machine, a spark machining apparatus, or the like. In the joining device 100, for example, the joining pin SPz is formed with a height greater than or equal to the height of the bottom surface of the joining material PP2 (contact surface which is the surface on the side of the joining base material BP). As described above, the joining device 100 forms the joining pin SPz passing through the through hole H1 to a height that does not exceed the upper surface of the joining material PP2 and is greater than or equal to the height of the bottom surface of the joining material PP2.

Next, the conveyance unit 30 of the joining device 100 passes the joining pin SPz through the through hole H1 of the joining materials PP1 and PP2 and the anti-electrolytic-corrosion sheets CP1 and CP2 (ST62). In this case, because the joining pin SPz is lower than the upper surface position of the joining material PP2, the joining pin SPz does not protrude from the upper surface of the joining material PP2.

Next, the joining device 100 additionally shapes a point bead or a line bead on the joining pin SPZ to increase the height of the joining pin SPz so as to be substantially flush with the height of the upper surface side of the joining material PP2. That is, the joining device 100 performs additional shaping on the joining pin SPz to bring the height of the upper surface of the joining pin SPz close to the height of the upper surface of the joining material PP2. At this time, the joining pin SPz and the side surface of the through hole H1 of the joining material PP2 are melted (by fusion penetration) and joined (ST63).

Finally, the joining device 100 performs joining without a protrusion, that is, with the height of the uppermost surface of the joining pin SPz flush with the height of the upper surface of the joining material PP2, by heating and melting (by fusion penetration) and smoothing the uppermost surface of the joining pin SPz and the periphery thereof (upper surface of the joining material PP2) with the heat source HS. In this case, because the joining pin SPz and the joining material PP2 are made of the same material or materials having similar properties, the joining pin SPz and the joining material PP2 are melted together on the uppermost surface of the joining pin SPz and the uppermost surface of the joining material PP2 (ST64). As a result, the joining device 100 produces a joint 43 at which the joining base material BP and the joining materials PP1 and PP2 are joined.

Note that the joining device 100 can apply the joining that does not use a protrusion not only to the three-layer structure but also to the joining of four layers as described in FIG. 18 or the joining of five or more layers. In the case of applying the joining that does not use a protrusion to the joining of four layers described in FIG. 18, the joining device 100 uses the same material or materials having similar properties for at least the joining base material BP, the joining pin SPy, and the joining material PP3.

In addition, depending on the thicknesses of the joining materials PP1 and PP2 or the diameter of the through hole H1, the joining device 100 may perform the joining process after disposing the joining materials PP1 and PP2 and the anti-electrolytic-corrosion sheets CP1 and CP2 on the joining base material BP before shaping the joining pin SPz.

### Fifth Embodiment

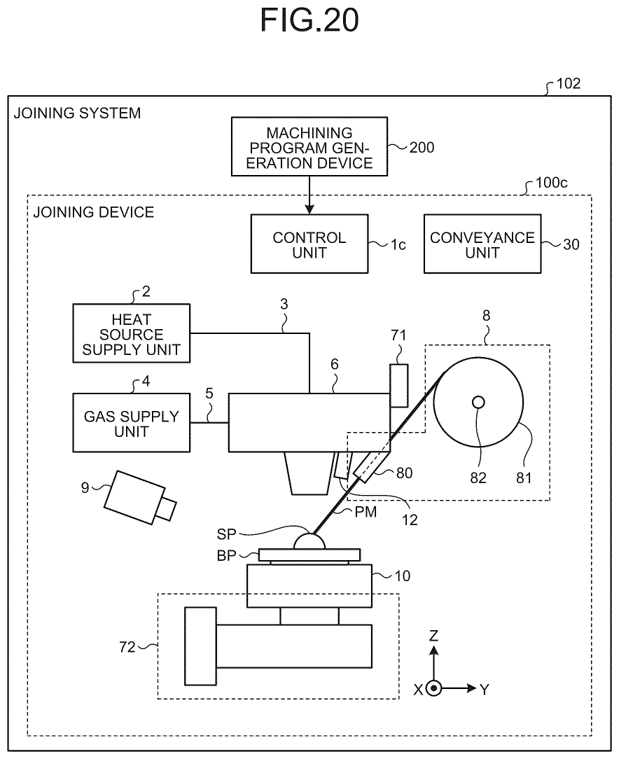

Next, the fifth embodiment will be described with reference to FIGS. 20 to 24. In the fifth embodiment, the post-correction command CCV is learned based on the difference in height between the target shape and the actual shape.

FIG. 20 is a diagram illustrating a configuration of a joining system according to the fifth embodiment. Components illustrated in FIG. 20 that achieve the same functions as those of the joining system 101 of the first embodiment illustrated in FIG. 1 are denoted by the same reference signs, and duplicate descriptions are omitted.

The joining system 102 according to the fifth embodiment includes a joining device 100c instead of the joining device 100 as compared with the joining system 101 according to the first embodiment. In addition, the joining device 100c includes a control unit 1c instead of the control unit 1 as compared with the joining device 100. Hereinafter, a case where the control unit 1c learns the post-correction command CCV that is used when executing additive manufacturing on the joining pin SP will be described.

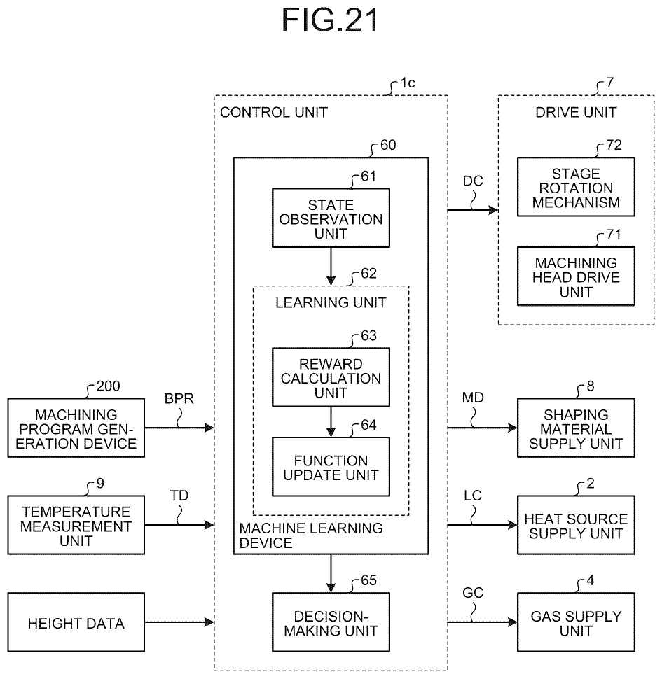

FIG. 21 is a diagram illustrating a configuration of the control unit included in the joining system according to the fifth embodiment. As compared with the control unit 1 in the first embodiment, the control unit 1c in the fifth embodiment includes a machine learning device 60 and a decision-making unit 65 in addition to the components included in the control unit 1. Similarly to the control unit 1, the control unit 1c includes the controller 52a, the differentiator 53, and the output unit 54, which are not illustrated in FIG. 21.

The machine learning device 60 includes a state observation unit 61 and a learning unit 62. The learning unit 62 includes a reward calculation unit 63 and a function update unit 64. The state observation unit 61 acquires a state quantity sₜ (not illustrated), which is a quantity related to the state of joining, including at least the basic machining program BPR, height data indicating the height of the additively manufactured joining pin SP, and the temperature data TD indicating the temperature of the joining pin SP during the additive manufacturing.

Examples of the state quantity sₜ included in the basic command BCV (not illustrated) of the basic machining program BPR, which is a machining program, include the shaping order, shaping direction, temperature during shaping, height of shaping, and molten pool width of the joining pin SP. Examples of the state quantity sₜ included in the joining condition PC (not illustrated) of the basic machining program BPR include laser output, radiation time, cooling time, and heating time.

The learning unit 62 learns the post-correction command CCV (not illustrated) for forming the joining pin SP according to a training dataset created based on the state quantity sₜ acquired by the state observation unit 61. Here, according to the training dataset, the learning unit 62 executes learning for determining the post-correction command CCV for use in forming the joining pin SP by additive manufacturing from the basic machining program BPR, the height data, and the temperature data TD.

Note that the learning unit 62 may execute learning for determining the post-correction machining program PPR. In this case, the learning unit 62 is considered to be executing learning for determining the post-correction command CCV because the post-correction command CCV is included in the post-correction machining program PPR.

The learning unit 62 may use any learning algorithm. An example in which the learning unit 62 uses reinforcement learning as the learning algorithm will be described. Reinforcement learning is a method in which an agent (subject of an action) in an environment observes the current state and determines the action to take. The agent gains a reward from the environment by selecting an action, and learns how to maximize the reward through a series of actions. Q-learning and TD-learning are known as representative methods of reinforcement learning. For example, in the case of Q-Learning, a general update expression (action value table) for the action value function Q (s, a) is expressed by Formula (1) below.

$$\begin{matrix}Formula 1 : & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 1 )\end{matrix}$$

In Formula (1), t represents the environment at time t, and at represents the action at time t. The action at changes the environment to sₜ₊₁. In addition, rₜ₊₁, represents the reward that can be gained due to the change of the environment, γ represents a discount rate, and a represents a learning coefficient. When the Q-learning is applied, the joining condition PC and the machining path serve as the action at. Note that γ is a value in the range of 0<γ≤1, and α is a value in the range of 0<α≤1. The update expression represented by Formula (1) increases the value of the action value function Q when the action value of the best action a at timeₜ₊₁, is greater than the value of the action value function Q of the action a executed at time t, and otherwise reduces the value of the action value function Q. In other words, the action value function Q (s, a) is updated such that the value of the action value function Q of the action a at time t is brought closer to the best action value at timeₜ₊₁. As a result, the best action value in a certain environment sequentially propagates to the action values in the previous environments.

The reward calculation unit 63 calculates the reward r based on the state quantity sₜ. For example, the reward calculation unit 63 increases the reward r when the error, i.e. difference in height between the target shape and the actual shape in each layer, is smaller than a specific value, and reduces the reward r when the error is larger than the specific value. For example, the reward calculation unit 63 gives a reward of one as a large reward, and gives a reward of minus one as a small reward. The function update unit 64 updates the action value function Q according to the reward r calculated by the reward calculation unit 63. The decision-making unit 65 determines the post-correction command CCV using the action value function Q. For example, in the case of Q-Learning, the decision-making unit 65 uses the action value function Q (sₜ, aₜ) represented by Formula (1) as a function for determining the machining path.

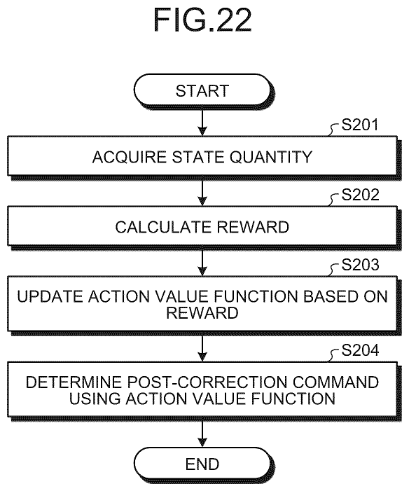

FIG. 22 is a flowchart illustrating a procedure for operation processing of the control unit according to the fifth embodiment. The operation illustrated in FIG. 22 may be executed at specific control intervals when the joining device 100c shapes the joining pin SP on the joining base material BP. The decision-making unit 65 determines the post-correction command CCV of the joining device 100c using the action value function Q determined by the machine learning device 60.

The joining device 100c performs the shaping process of the joining pin SP according to the determined post-correction command CCV. Then, the state observation unit 61 acquires the state quantity sₜ corresponding to the shaping process (step S201). The state quantity sₜ is, for example, the measurement value of the bead height of the shaped portion in each layer measured by the height sensor, and the measurement value of the temperature of the shaped portion in each layer measured by the temperature measurement unit 9. The reward calculation unit 63 calculates the reward r based on the state quantity sₜ (step S202).

For example, the reward calculation unit 63 calculates the error between the height of the joining pin SP detected in each layer and the target height in each layer, and determines whether the error is equal to or lower than a threshold or exceeds the threshold. In addition, the reward calculation unit 63 calculates the error between the temperature of the joining pin SP detected in each layer and the target temperature in each layer, and determines whether the error is equal to or lower than a threshold or exceeds the threshold.

In response to determining that the error in the height of the joining pin SP is equal to or lower than the threshold, the reward calculation unit 63 gives a large reward. On the other hand, in response to determining that the error in the height of the joining pin SP exceeds the threshold, the reward calculation unit 63 gives a small reward. In addition, in response to determining that the error in temperature is equal to or lower than the threshold, the reward calculation unit 63 gives a large reward. On the other hand, in response to determining that the error in temperature exceeds the threshold, the reward calculation unit 63 gives a small reward.

By calculating the reward at the reward calculation unit 63 in this manner, learning for executing additive manufacturing is executed, and the joining device 100c can improve the accuracy of additive manufacturing.

The function update unit 64 updates the action value function Q based on the reward r (step S203). The decision-making unit 65 determines the post-correction command CCV using the updated action value function Q (step S204). Here, the decision-making unit 65 may determine the post-correction machining program PPR based on the updated action value function Q.

Although reinforcement learning is used in the example of the fifth embodiment, the machine learning device 60 may execute machine learning according to another known method, e.g. a neural network, genetic programming, functional theory programming, or a support vector machine.

In addition, a part or all of the control unit 1c may be connected to the parts of the joining device 100c except the control unit 1c via a network, for example. Furthermore, a part or all of the control unit 1c may exist on a cloud server.

In addition, a learned learning machine that has already executed learning with the machine learning device 60 may be applied to another joining device different from the joining device 100c on which the learning has been executed. The learned learning machine is a learning machine that has executed learning for determining the post-correction command CCV for producing the joining pin SP by means of additive manufacturing from the basic machining program BPR and the temperature data TD based on the state quantity sₜ. The learned learning machine may be, for example, the decision-making unit 65 having the updated action value function Q for which the update has been executed. In this case, another joining device different from the joining device 100c includes the decision-making unit 65 having the action value function Q. This different joining device including the decision-making unit 65 includes the state observation unit 61 that observes the state quantity sₜ, that is a quantity related to the state of additive manufacturing of the joining pin SP including the basic machining program BPR and the temperature data TD.

By using the state observation unit 61 and the learned learning machine, the different joining device described above can determine the post-correction command CCV for producing the joining pin SP by additive manufacturing without performing new learning, and execute the additive manufacturing of the joining pin SP with high accuracy.

In addition, the control unit 1c may have a configuration in which the decision-making unit 65 is omitted from the configuration of FIG. 21. That is, the control unit 1c may be configured to perform learning but not to determine the post-correction command CCV. In this case, the control unit 1c that does not determine the post-correction command CCV repeatedly acquires the state quantity sₜ from the outside using the machine learning device 60 to repeatedly execute learning, and sends the learned learning machine that is the learning result to the above-described joining device different from the joining device 100c. The joining device different from the joining device 100c determines the post-correction command CCV using the learned learning machine having the learning result.

Although the control unit 1c in FIG. 20 controls one joining device 100c, the machine learning device 60 may be connected to the machine device portions of a plurality of joining devices. Here, the parts of the joining device 100c except the machine learning device 60, for example, the parts of the joining device 100c except the machine learning device 60, are referred to as the machine device portion. The machine learning device 60 may acquire the state quantity sₜ from the machine device portions of a plurality of joining devices connected to the machine learning device 60. The machine device portions may be a plurality of devices used in the same site or may be devices independently operated in different sites.

Furthermore, a new machine device portion may be added to the list of machine device portions from which the machine learning device 60 collects datasets in the middle of dataset collection, or some machine device portion may be removed from the list in the middle of dataset collection. Furthermore, the machine learning device 60 that has executed learning for some machine device portion may be attached to a different machine device portion so that the different machine device portion can relearn to update the learning result.

As described above, the joining device 100c according to the fifth embodiment includes the state observation unit 61 that observes, as the state quantity sₜ, a quantity related to additive manufacturing including at least the basic command BCV, the joining condition PC, and the temperature data TD. In addition, the joining device 100c includes the learning unit 62 that learns the post-correction command CCV for use in executing additive manufacturing from the basic command BCV, the joining condition PC, and the temperature data TD based on the state quantity sₜ.

In addition, the joining device 100c may include the state observation unit 61 that observes, as the state quantity sₜ, a quantity related to additive manufacturing including at least the basic command BCV, the joining condition PC, and the temperature data TD, and a learned learning machine (decision-making unit 65 or the like) that has learned the post-correction command CCV for use in executing additive manufacturing from the basic command BCV, the joining condition PC, and the temperature data TD based on the state quantity sₜ.

As described above, according to the fifth embodiment, the joining device 100c learns the post-correction command CCV based on the basic command BCV, the joining condition PC, and the temperature data TD, and additively manufactures the joining pin SP using the post-correction command CCV, so that the shaping accuracy of the joining pin SP can be improved.

Subsequently, the hardware configuration of the control units 1 and 1c will be described. The control units 1 and 1c are implemented by processing circuitry. The processing circuitry may be a memory and a processor that executes a program stored in the memory, or may be dedicated hardware such as a dedicated circuit. The processing circuitry is also called a control circuit.

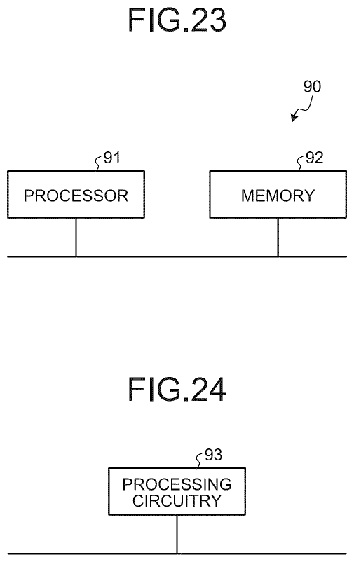

FIG. 23 is a diagram illustrating an exemplary configuration of processing circuitry in the case that the processing circuitry provided in the control unit according to the first to fifth embodiments is implemented by a processor and a memory. The processing circuitry 90 illustrated in FIG. 23 is a control circuit and includes a processor 91 and a memory 92. In a case where the processing circuitry 90 is configured with the processor 91 and the memory 92, each function of the processing circuitry 90 is implemented by software, firmware, or a combination of software and firmware. Software or firmware is described as a program and stored in the memory 92. In the processing circuitry 90, the processor 91 reads and executes the program stored in the memory 92, thereby implementing each function. That is, the processing circuitry 90 includes the memory 92 for storing the programs that result in the processing of the control units 1 and 1c. It can also be said that this program is a program for causing the control units 1 and 1c to execute each function implemented by the processing circuitry 90. This program may be provided by a storage medium in which the program is stored, or may be provided by other means such as a communication medium. It can also be said that the program is a program that causes the control units 1 and 1c to execute control processing.

The processor 91 is exemplified by a central processing unit (CPU), a processing device, an arithmetic device, a microprocessor, a microcomputer, or a digital signal processor (DSP). Examples of the memory 92 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

FIG. 24 is a diagram illustrating an example of processing circuitry in the case that the processing circuitry provided in the control unit according to the first to fifth embodiments is implemented by dedicated hardware. For example, the processing circuitry 93 illustrated in FIG. 24 is a single circuit, a composite circuit, a programmed processor, a parallel programmed processor, an application specific integrated circuit (ASIC), a field programmable gate array (FPGA), or a combination thereof. The processing circuitry 93 may be partially implemented by dedicated hardware, and partially implemented by software or firmware. In this manner, the processing circuitry 93 can implement the above-described functions using dedicated hardware, software, firmware, or a combination thereof.

The configurations described in the above-mentioned embodiments indicate examples. The embodiments can be combined with another well-known technique and with each other, and some of the configurations can be omitted or changed in a range not departing from the gist.

### REFERENCE SIGNS LIST

1, 1c control unit; 2 heat source supply unit; 3 heat source path; 4 gas supply unit; 5 gas supply path; 6 machining head; 7 drive unit; 8 shaping material supply unit; 9 temperature measurement unit; 10 stage; 12 dust collector; 13 gas nozzle; 14 heat source supply nozzle; 16a rotation member; 30 conveyance unit; 40 to 43 joint; 52a controller; 53 differentiator; 54 output unit; 60 machine learning device; 61 state observation unit; 62 learning unit; 63 reward calculation unit; 64 function update unit; 65 decision-making unit; 71 machining head drive unit; 72 stage rotation mechanism; 80 wire nozzle; 81 wire spool; 82 spool drive device; 90, 93 processing circuitry; 91 processor; 92 memory; 100, 100c joining device; 101, 102 joining system; 200 machining program generation device; A1 central region; A2 outer circumferential region; BP joining base material; C1, C2 covering portion; CP, CP1 to CP3 anti-electrolytic-corrosion sheet; G shield gas; H1, H2 through hole; OP object; P1, Pn pin layer; PM, PMx shaping material; PP, PP1 to PP3 joining material; Q1, Q2 pin layer; R1, R2 pin portion; Rx path; SP, SP0 to SP8, SPx, SPy, SPz joining pin; W1 spacer.

1.-18. (canceled)

19. A joining method comprising:
performing additive manufacturing of a joining pin consisting of pin layers in a machining region on a joining surface of a first material body to be joined made of a first material, by performing material supply for supplying a first shaping material that is one type of a wire-like shaping material to the machining region, heating and melting for supplying a heat source to the machining region to melt the first shaping material, bead shaping for solidifying the first shaping material melted into a rod shape or a hemispherical shape by utilizing surface tension of the first shaping material, and pin shaping for depositing pin layers formed by the bead shaping in a plurality of stages;
disposing the first material body to be joined and a second material body to be joined made of a second material different from the first material and having a through hole that allows the joining pin to pass through, such that the joining pin passes through at least a part of the through hole; and
forming a fixed protrusion that fixes the first material body to be joined and the second material body to be joined by machining the joining pin, wherein
a first outer circumferential shape that is an outer circumferential shape of the fixed protrusion viewed from a pass-through direction is larger than a second outer circumferential shape that is an outer circumferential shape of an outlet of the through hole.

20. The joining method according to claim 19, wherein
in the disposing the first material body to be joined and the second material body to be joined, the second material body to be joined and the first material body to be joined are disposed such that the joining pin passes through the through hole of the second material body to be joined and protrudes from the through hole, and
in the forming the fixed protrusion, the fixed protrusion that fixes the first material body to be joined and the second material body to be joined are formed by machining a protrusion that is a portion of the joining pin protruding from the through hole.

21. The joining method according to claim 20, wherein
the disposing the first material body to be joined and the second material body to be joined includes a process for disposing an anti-electrolytic-corrosion sheet between the second material body to be joined and the joining surface, the anti-electrolytic-corrosion sheet being made of an insulating material or a material having a potential difference of less than 100 mV with respect to both the first material and the second material.

22. The joining method according to claim 20, wherein
in the forming the fixed protrusion, the fixed protrusion is formed by deforming the protrusion.

23. The joining method according to claim 22, wherein
in the forming the fixed protrusion, the protrusion is deformed by applying pressure to the protrusion and pressing the protrusion against the second material body to be joined.

24. The joining method according to claim 20, wherein
in the forming the fixed protrusion, the fixed protrusion is formed such that a part of the first outer circumferential shape sticks out from the second outer circumferential shape and another part of the first outer circumferential shape fits inside a region of the second outer circumferential shape.

25. The joining method according to claim 24, wherein
in the forming the fixed protrusion, the fixed protrusion is formed such that an area of the fixed protrusion viewed from the pass-through direction increases from a side where the fixed protrusion is in contact with the second material body to be joined toward an upper end of the fixed protrusion.

26. The joining method according to claim 20, wherein
in the additive manufacturing of a joining pin, the joining pin is additively manufactured such that an axial portion of the joining pin has a hollow structure.

27. The joining method according to claim 20, wherein
in the forming the fixed protrusion, an annular member surrounding a side surface of the protrusion is disposed on the second material body to be joined such that the annular member surrounds the side surface of the protrusion, and the fixed protrusion is formed by joining the annular member disposed and the protrusion by performing fusion penetration between the annular member and the protrusion.

28. The joining method according to claim 20, wherein
a surface of the second material body to be joined from which the protrusion projects includes a recess, and
the fixed protrusion is fit to the recess.

29. The joining method according to claim 27, wherein
a surface of the second material body to be joined from which the protrusion projects includes a recess, and
the annular member is fit to the recess.

30. The joining method according to claim 20, further comprising
additively manufacturing a covering portion to cover the fixed protrusion by performing material supply for supplying a second shaping material to a specific region of the second material body to be joined having the fixed protrusion formed, and heating and melting for supplying a heat source for heating to melt the second shaping material.

31. The joining method according claim 20, wherein
in the additive manufacturing of the joining pin, the joining pin including a first pin portion and a second pin portion is additively manufactured by additively manufacturing the first pin portion and the second pin portion using a plurality of types of the first shaping materials, the first pin portion being formed on the first material body to be joined, the second pin portion being made of a material different from that of the first pin portion, deposited on an upper side of the first pin portion, passing through the through hole, and protruding from the through hole.

32. The joining method according to claim 20, wherein
a plurality of the second material bodies to be joined are provided, and
in the disposing the first material body to be joined and the second material body to be joined, the second material bodies to be joined and the first material body to be joined are disposed such that the joining pin passes through the through hole of each of the second material bodies to be joined, and the joining pin protrudes from the through hole of the second material body to be joined disposed in an uppermost stage among the plurality of the second material bodies to be joined.

33. The joining method according to claim 19, wherein
a plurality of the second material bodies to be joined are provided,
in the additive manufacturing of a joining pin,
the joining pin is additively manufactured, using the first shaping material, such that the joining pin passes through the through hole to a height that does not exceed the through hole disposed in the uppermost stage among the through holes and is greater than or equal to a height of a bottom surface that is a contact surface, on a side of the first material body to be joined, of the second material body to be joined disposed in the uppermost stage among the plurality of second material bodies to be joined,
additional additive manufacturing is performed on an upper portion of the joining pin using the first shaping material, the joining pin and a through-hole side surface portion of the second material body to be joined disposed in the uppermost stage are subjected to fusion penetration, and a height of the joining pin is increased to be the same as a height of an upper surface side that is a non-contact surface, not in contact with the second material body to be joined in a lower stage, of the second material body to be joined disposed in the uppermost stage, and
an upper surface of the second material body to be joined and an uppermost surface of the joining pin with the height increased to be the same as the height of the upper surface of the second material body to be joined are subjected to fusion penetration to implement joining without a protrusion.

34. A joining device comprising:
shaping material supply circuitry to supply a first shaping material that is one type of wire-like shaping material to a machining region on a joining surface of a first material body to be joined made of a first material;
heat source supply circuitry to perform additive manufacturing of a joining pin consisting of pin layers in a machining region by performing heating and melting for supplying a heat source for heating to the machining region to melt the first shaping material, bead shaping for solidifying the first shaping material melted into a rod shape or a hemispherical shape by utilizing surface tension of the first shaping material, and pin shaping for depositing pin layers formed by the bead shaping in a plurality of stages;
conveyance circuitry to dispose the first material body to be joined and a second material body to be joined made of a second material different from the first material and having a through hole that allows the joining pin to pass through, such that the joining pin passes through at least a part of the through hole; and
control circuitry to control the shaping material supply circuitry, the heat source supply circuitry, and the conveyance circuitry based on a machining program including a basic command for executing the additive manufacturing and a joining condition for executing the additive manufacturing, wherein
a fixed protrusion that fixes the first material body to be joined and the second material body to be joined is formed by machining the joining pin, and
a first outer circumferential shape that is an outer circumferential shape of the fixed protrusion viewed from a pass-through direction is larger than a second outer circumferential shape that is an outer circumferential shape of an outlet of the through hole.

35. The joining device according to claim 34, wherein
the control circuitry corrects the basic command based on height data indicating a height of the joining pin and temperature data indicating a temperature of the joining pin in the machining region, and controls the shaping material supply circuitry, the heat source supply circuitry, and the conveyance circuitry based on the basic command corrected.

36. The joining device according to claim 35, comprising:
state observation circuitry to observe, as a state quantity, a quantity related to a state of joining including the basic command, the joining condition, the height data, and the temperature data; and
learning circuitry to execute, according to a training dataset created based on the state quantity, learning for determining the basic command corrected for use in forming the joining pin by the additive manufacturing from the basic command, the joining condition, the height data, and the temperature data.

37. A joining system comprising:
the joining device according to claim 34; and
a machining program generation device to generate the machining program.
